(19) United States
(12) Patent Application Publication
(10) Pub. No.: US 2025/0366417 A1
(43) Pub. Date: Dec. 4, 2025

(54) SELF-CONTAINED ASSISTIVE MODULAR PLANTERS

(71) Applicant: GEOBULL LLC, Round Rock, TX (US)

(72) Inventors: Michael Healey, Round Rock, TX (US); Richard Malcolm Fincke, New Braunfels, TX (US); Eric Overton, Round Rock, TX (US)

(73) Assignee: GEOBULL LLC, Round Rock, TX (US)

(21) Appl. No.: 18/876,124

(22) PCT Filed: Jun. 16, 2023
(86) PCT No.: PCT/US2023/068604

§ 371 Date: Dec. 17, 2024

Related U.S. Application Data
(60) Provisional application No. 63/366,541, filed on Jun. 17, 2022.

(51) Int. Cl. A01G 27/06; A01G 27/00

(52) U.S. Cl. CPC A01G 27/06; A01G 27/003

(57) ABSTRACT

Apparatus and associated methods relate to a soil controlling gardening box (SCGB). In an illustrative example, an exemplary SCGB may include a plant growing medium defined by side walls, and a liquid reservoir. For example, the SCGB may include a heating element disposed in at least one of the side walls and configured to be in direct with the plant growing medium. For example, the side walls may include a thermal barrier layer coated on opposite sides. For example, each side may be coated by a protective layer of quick curing material that may be heat resistant. For example, the heat element may be disposed at an outer surface of an inner coating of the at least one side wall. Various embodiments may advantageously thermally separate the thermal barrier layer from the thermal energy generated by the heating element.

### CROSS-REFERENCE TO RELATED APPLICATIONS

This application claims the benefit of U.S. Provisional Application Ser. No. 63/366,541, titled “Self-Contained Assistive Modular Planters,” filed by Michael Healey, et al., on Jun. 17, 2022. This application incorporates the entire contents of the foregoing application(s) herein by reference.

### TECHNICAL FIELD

Various embodiments relate generally to above ground gardening apparatus and methods.

### BACKGROUND

As population of recent times tends into the urban and suburban communities, there is a great demand for purchasing fresh and nutrient rich fruits and vegetables. Some people may try to build gardens to grow vegetables and fruit. However, the process may involve recurring and time-consuming issues from materials used to build their gardens.

In one aspect, there is a risk of using certain materials in and around a garden. In particular, the material used may relate to a health risk for families from leaching toxins. Most people may, for example, start by digging out a space in the ground ranging from eighteen to twenty-four inches deep to prepare the soil. Next, some may face, for example, issues from maintenance of maintaining the garden at a ground level that becomes a back breaking work especially in hot summer. In various examples, people may start to look around for a better solution to relieve knee and back pain. In some examples, fungal infections may be resulted due to working in ground fields. To alleviate this situation, above ground gardens have gained popularity over the last several decades that have become the norm.

In another aspect, modular gardening boxes may be used in urban settings with limited space (e.g., on balconies or rooftops, in larger gardens). The modular design may, for example, allow gardeners to create multi-level arrangements, maximizing the use of vertical space. In some examples, the portability of these boxes may allow easy relocation or reconfiguration.

For example, modular gardening boxes may offer ease of maintenance and organization. Gardeners, for example, may manage and care for each box separately. For example, it may be easier to monitor plant health, control pests, and apply fertilizers or treatments independently and selectively. The modularity also allows for experimentation with different plant combinations and aesthetic arrangements, for example.

### SUMMARY

Apparatus and associated methods relate to an exemplary smart automatic garden box (SAGB). In an illustrative example, the SAGB may include side walls made of Expanded Polystyrene (EPS) and coated with Polyurea (PU). The EPS, for example, may provide a light-weight core and/or insulative attribute. The PU layer may, for example, provide strength and abrasion resistance. A windcatcher tower, in some examples, may be included to induce air flow in a wicking bed of the SAGB to advantageously prevent bacterial, pathogenic, parasitic, and other undesirable to build up. The side walls, for example, may include a layered structure including a heating element for controlling temperature of soil in the SAGB. The SAGB may further include a computer controller to control environmental parameters in the SAGB. Various embodiments may advantageously facilitate convenient and automatic above ground gardening.

Apparatus and associated methods relate to a soil controlling gardening box (SCGB) that is durable and highly abrasion resistant. In an illustrative example, an exemplary SCGB may include a plant growing medium defined by side walls, and a liquid reservoir. For example, the SCGB may include a heating element disposed in at least one of the side walls and configured to be in direct with the plant growing medium. For example, the side walls may include a thermal barrier layer coated on opposite sides. For example, each side may be coated by a protective layer of quick curing material that may be heat resistant. For example, the heat element may be disposed at an outer surface of an inner coating of the at least one side wall. Various embodiments may advantageously thermally separate the thermal barrier layer from the thermal energy generated by the heating element.

Apparatus and associated methods relate to an application of a coating to a substrate to create a durable wall, such as for gardening. In an illustrative example, a method to manufacture a layered wall may include providing a thermal barrier layer comprising a predetermined deformation energy, and disposing a reflective layer on at least one side of the thermal barrier layer to create a core layer. For example, the reflective layer may include a thermal insulating material. The method may include, for example, applying a protective coating to the core layer for a predetermined application duration. For example, the protective coating may include polyurea. For example, the protective coating may be applied at an application temperature higher than 120° F. For example, the protective coating may include a curing time less than 10 seconds. Various embodiments may advantageously prevent the thermal barrier layer from deforming throughout the coating application process.

Apparatus and associated methods relate to an above ground gardening box that includes a passive air flow system to induce air flow in an enclosed reservoir. In an illustrative example, an exemplary SCGB may include a plant growing volume defined by at least one side wall holding a plant growing medium. For example, the SCGB may include a wicking bed disposed below the plant growing volume, and a connection pipe fluidly connected to the wicking bed. For example, the SCGB may include a flow inducing feature fluidly connected to through the liquid reservoir the connection pipe. For example, the flow inducing feature may be exposed to ambient air. Various embodiments may advantageously induce an airflow between the ambient air and the liquid reservoir when there is a pressure differential between the ambient air and the liquid reservoir.

Apparatus and associated methods relate to an above ground gardening box that includes an actively controlled cover. In an illustrative example, an exemplary SAGB may include a plant growing volume defined by at least one side wall. For example, the plant growing volume is configured to hold a plant growing medium. The SAGB, for example, may include a box cover and a controller. For example, the controller may generate a weather forecast based on information retrieved from an information source including a remote weather station and/or sensors locally coupled to the controller. Based on the weather forecast and a type of plant growing in the SAGB, the controller may automatically activate the protective cover. For example, in an activated mode, the protective cover may sealingly enclose the plant growing volume. Various embodiments may advantageously protect plants growing in the SAGB from extreme weather conditions.

Apparatus and associated methods relate to an above ground gardening box that includes an actively controlled soil moisture. In an illustrative example, an exemplary SAGB may include a plant growing medium moisturized by liquids from a liquid reservoir. The SAGB, for example, may include a fill level sensor to measure a fill level of the liquid reservoir. For example, the SAGB may include a moisture sensor to measure a moisture level of the plant growing medium. A controller may, for example, be operably coupled to the fill level sensor and the moisture sensor to regulate a moisture level of the plant growing medium. For example, the controller may generate a signal as a function of the level measurement and the minimum fill level specified in the soil profile. Various embodiments may advantageously actively regulate the soil moisture within a controlled rate of change of moisture level in the soil.

Apparatus and associated methods relate to an above ground gardening box that includes an actively controlled temperature. In an illustrative example, an exemplary SAGB may include temperature sensors distributed throughout a plant growing medium. A controller operably coupled to the temperature sensors may generate a 3D temperature matrix of the plant growing medium and compare the 3D temperature matrix to the temperature threshold matrix stored in a soil profile. For example, the controller may generate a temperature control signal as a function of the compare result. The soil profile may also include a maximum rate of temperature change in the plant growing medium. For example, the temperature control signal may be generated as a function of the maximum rate of temperature change. Various embodiments may advantageously actively regulate a soil temperature less than or equal to the maximum rate specified in the soil profile.

Apparatus and associated methods relate to an above ground gardening box that includes an actively controlled impedance. In an illustrative example, an exemplary SAGB may include a target (e.g., optimal) range of electrical potential as a function of a predetermined rate of ions flow, and a potential sensor disposed within a plant growing medium (PGM). For example, a controller may regulate an impedance in the PGM by o applying a low charge to the SAGB. For example, the controller may compare an electrical potential from the potential sensor to a target range of electrical potential. The controller may generate a signal to control the low power charge application device to adjust a current flow within the PGM. Various embodiments may advantageously actively regulate ions flow in the PGM to facilitate nutrient absorption at a root of plants in the PGM.

Apparatus and associated methods relate to an above ground gardening box that includes a bulkhead coupled to a reservoir. In an illustrative example, an exemplary SCGB may include an inner module and an outer module. For example, the inner and outer modules may be coupled across a side wall of the reservoir of the SCGB to provide water and air access to the reservoir. For example, each of the inner module and the outer module may include a sealing member and at least one one-way engagement feature. For example, once the engagement features of the inner module and the outer module are registered and engaged with each other in one direction, movement of the inner module and the outer module opposite direction may be prevented. Various embodiments may advantageously control fluid movement into and out of the reservoir.

The details of various embodiments are set forth in the accompanying drawings and the description below. Other features and advantages will be apparent from the description and drawings, and from the claims.

### BRIEF DESCRIPTION OF THE DRAWINGS

FIG. 1A, FIG. 1B, and FIG. 1C depict an exemplary Soil Controlling Garden Box (SCGB) embodied as a Smart Automatic Gardening Box (SAGB) employed in an illustrative use-case scenario.

FIG. 2A and FIG. 2B are side cross-section views of an exemplary SCGB showing a close-up diagram of exemplary layers of a layered garden wall.

FIG. 3A depicts an exemplary bulkhead valve.

FIG. 3B and FIG. 3C are schematic diagrams showing orthogonal cross-section views of the exemplary bulkhead valve as described with reference to FIG. 3A.

FIG. 4 shows air flows within an exemplary SCGB using an exemplary windcatcher tower.

FIG. 5A is a schematic diagram showing air flows in an exemplary SCGB based on a pressure difference in a first embodiment.

FIG. 5B is a schematic diagram showing air flows in an exemplary SCGB based on a pressure difference in a second embodiment.

FIG. 6A and FIG. 6B show a perspective view and a bottom view, respectively, of an exemplary windcatcher tower cap.

FIG. 7A shows an exemplary fill vent.

FIG. 7B shows an exemplary vent screen configured to be coupled to the fil vent described with reference to FIG. 7A.

FIG. 8 is a graph showing an exemplary temperature profile at an exemplary gardening wall during an exemplary coating application process.

FIG. 9 is a flowchart illustrating an exemplary layered garden wall manufacturing method.

FIG. 10 is a block diagram showing an exemplary gardening condition controller (GCC).

FIG. 11 is a block diagram of exemplary external actuators used in a GCC as described with reference to FIG. 10.

FIG. 12 is a flowchart illustrating an exemplary smart automatic gardening method.

FIG. 13 is a block diagram depicting an exemplary soil temperature regulation system of an exemplary assistive gardening pod (AGP).

FIG. 14A is a block diagram depicting an exemplary soil moisture regulation system of an exemplary AGP.

FIG. 14B and FIG. 14C are block diagrams depicting exemplary water supply systems configured to supply one or more SAGBs.

FIG. 15 is a block diagram depicting an exemplary soil impedance regulation system of an exemplary AGP.

FIG. 16 depicts an exemplary block diagram of the exemplary plant growth optimization engine (PGOE).

FIG. 17 depicts an exemplary method of training a PGOE.

FIG. 18 is a block diagram depicting an exemplary cover control system of an exemplary AGP.

FIG. 19 is a flowchart illustrating an exemplary soil temperature regulation method.

FIG. 20 is a flowchart illustrating an exemplary soil moisture regulation method.

FIG. 21 is a flowchart illustrating an exemplary soil impedance regulation method.

FIG. 22 is a flowchart illustrating an exemplary garden pod cover control method.

FIG. 23 is a flowchart illustrating an exemplary method to determine a protective coating to be applied to a thermal barrier layer.

Like reference symbols in the various drawings indicate like elements.

### DETAILED DESCRIPTION OF ILLUSTRATIVE EMBODIMENTS

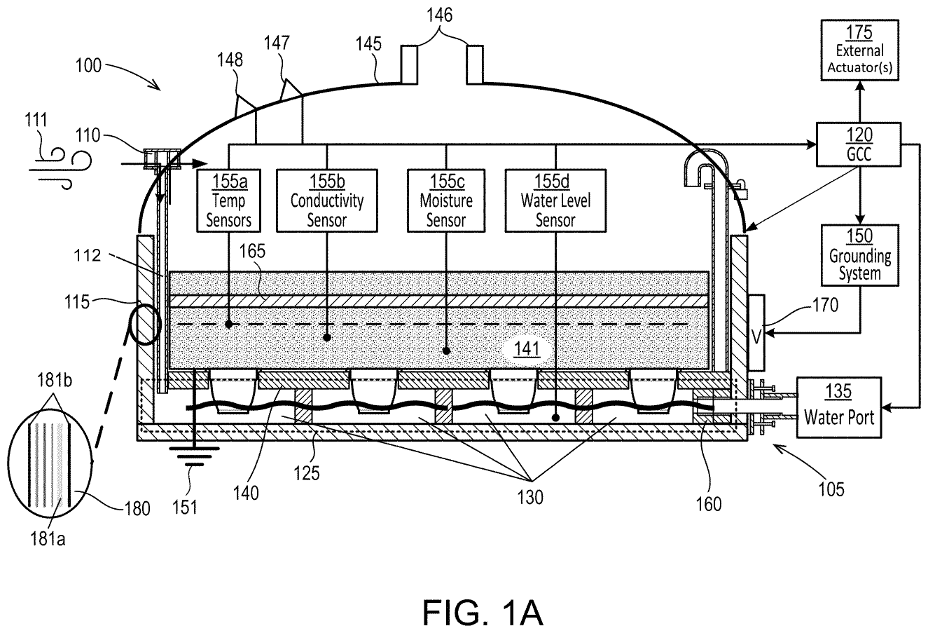

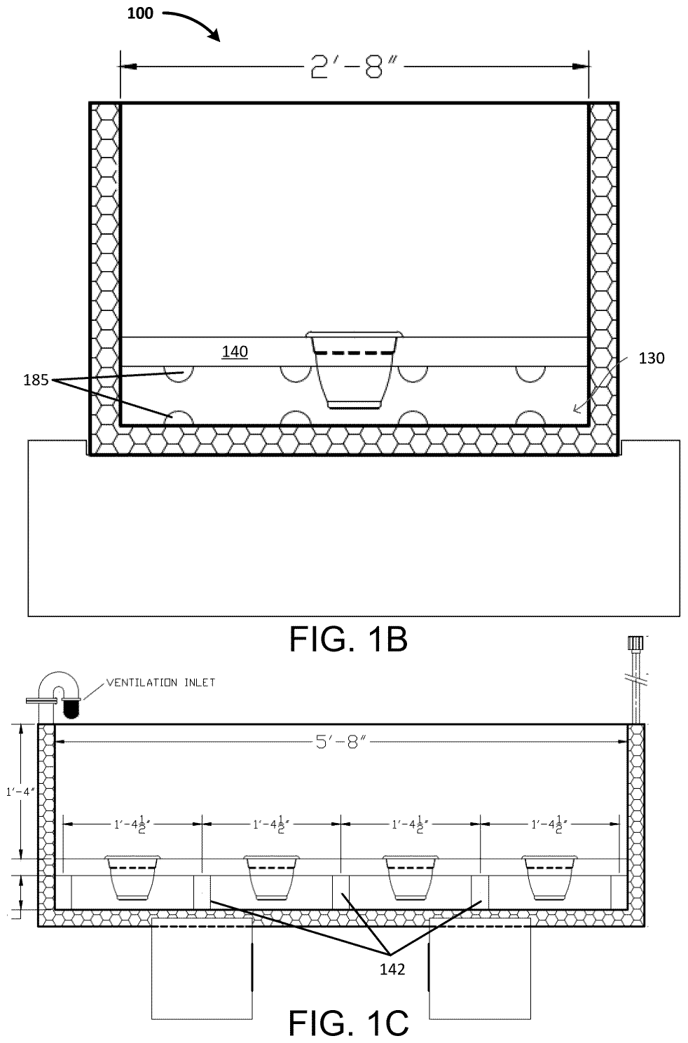

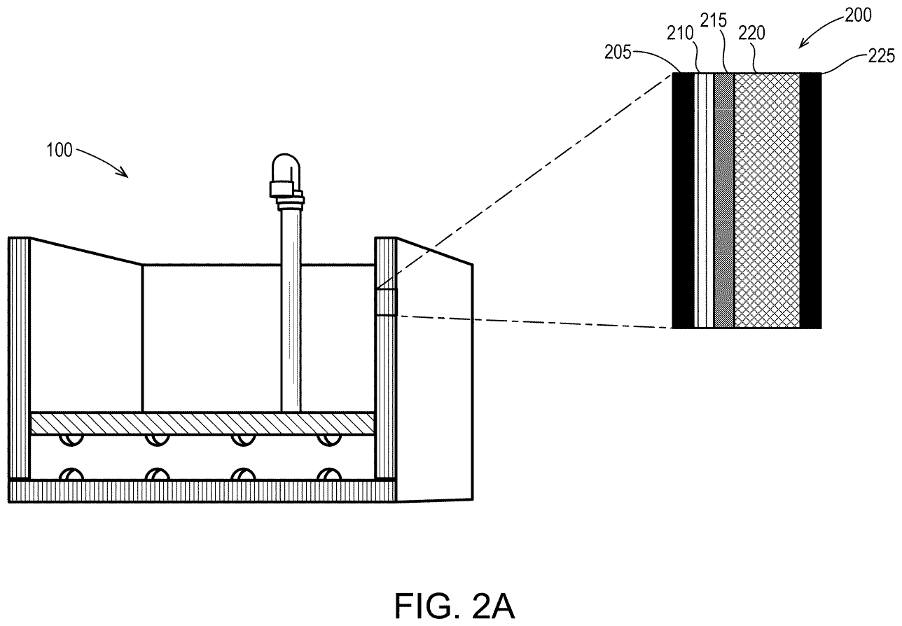

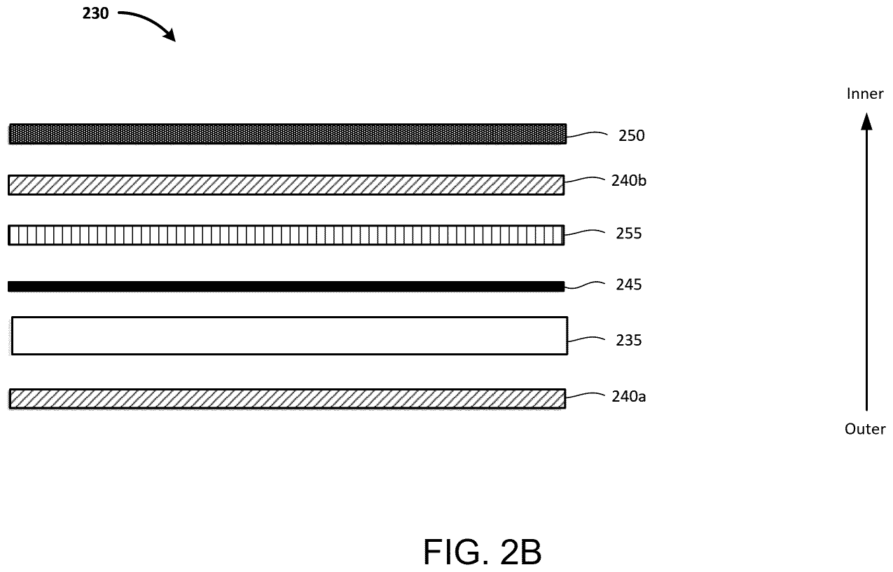

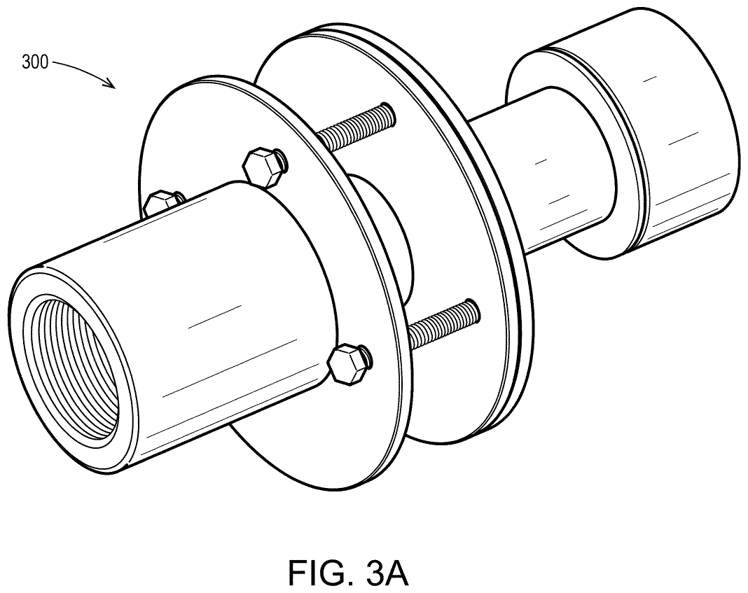

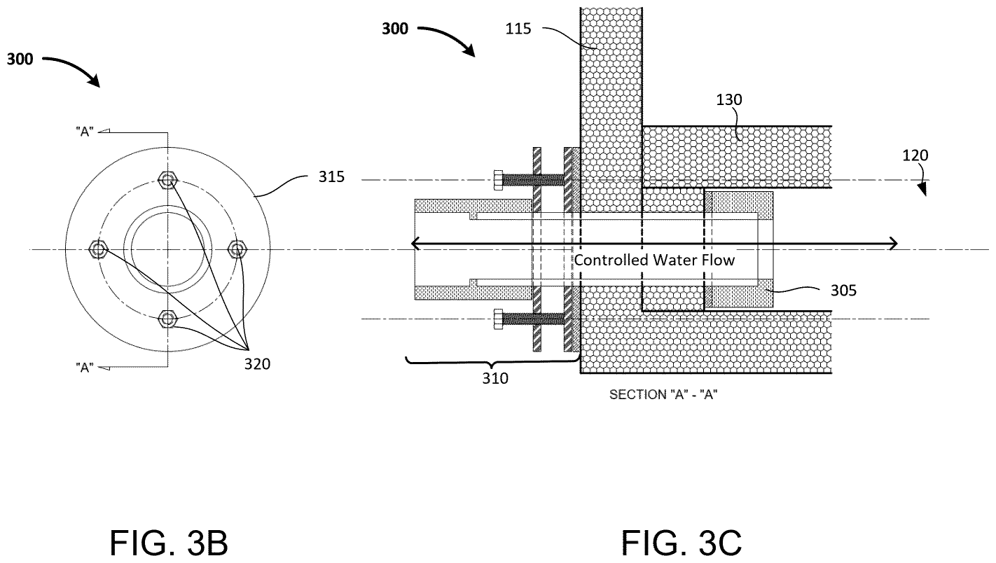

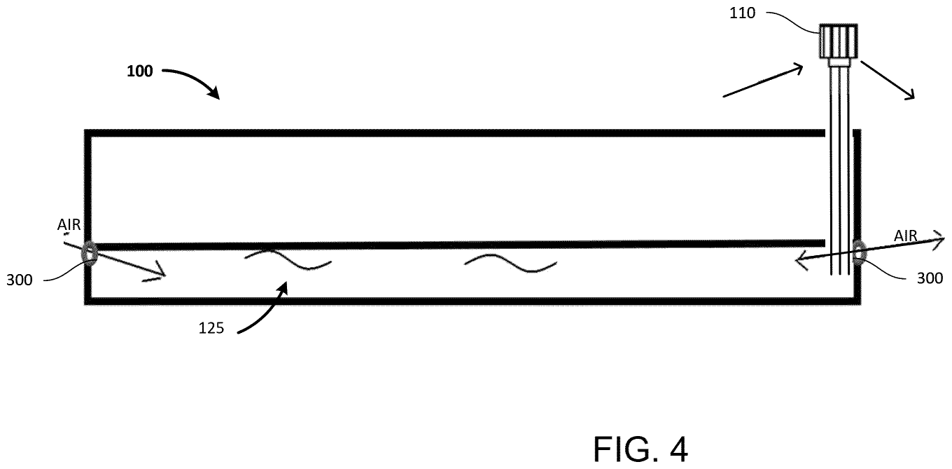

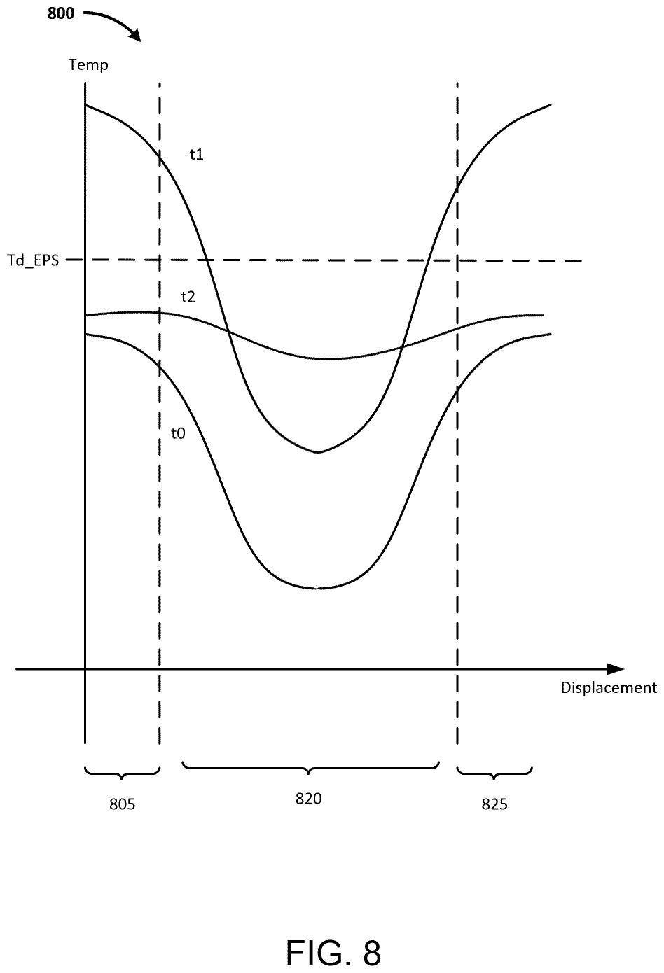

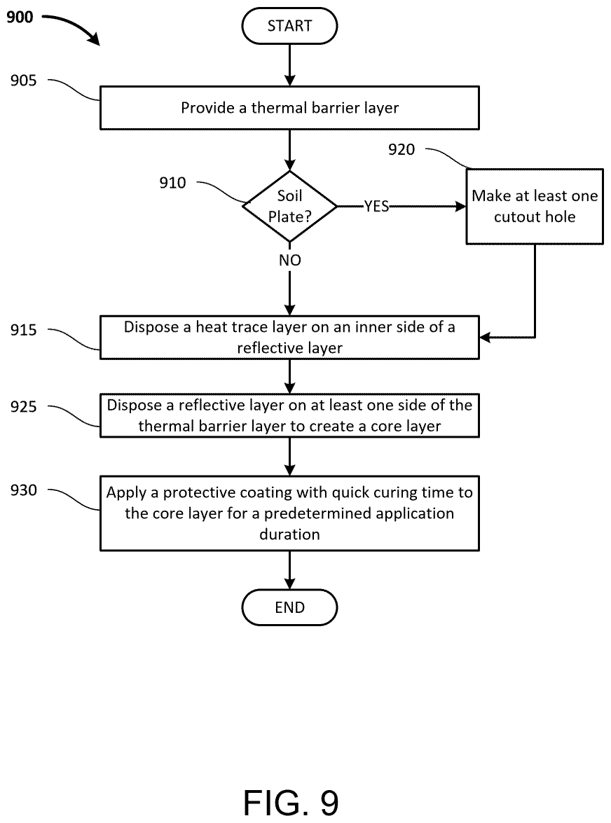

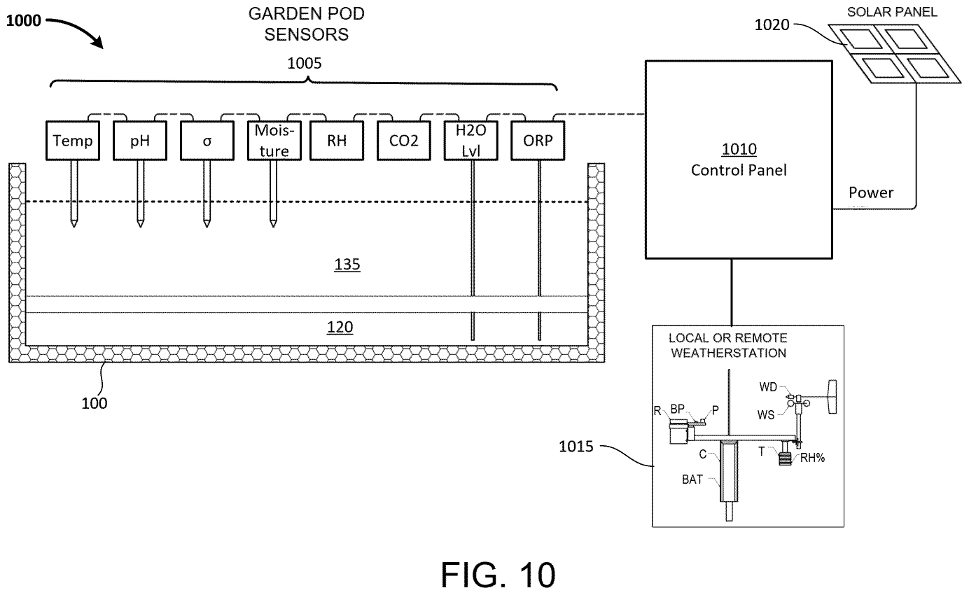

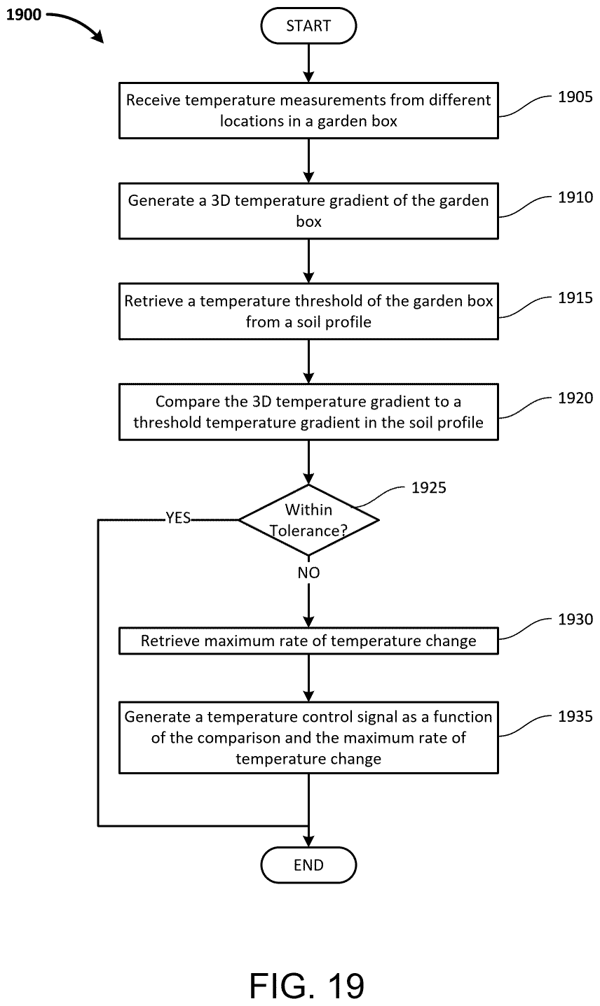

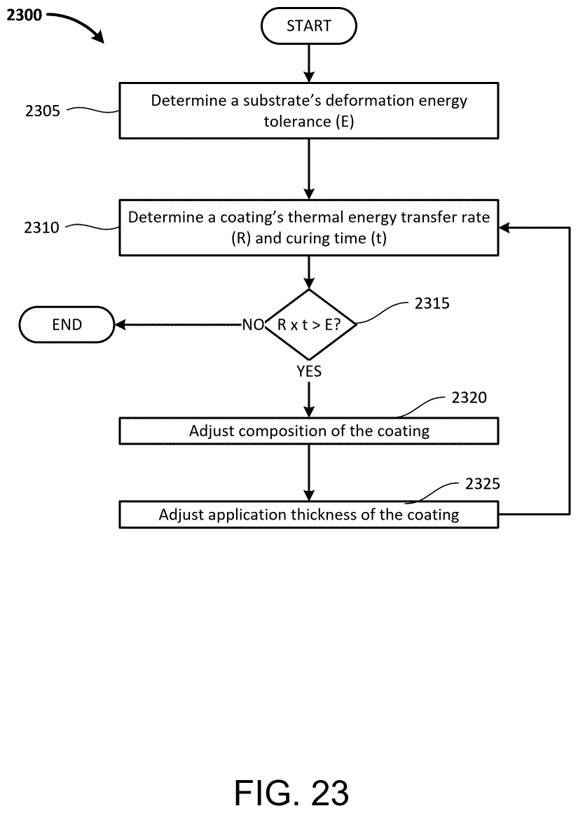

To aid understanding, this document is organized as follows. First, to help introduce discussion of various embodiments, a Soil Controlling Gardening Box (SCGB) is introduced with reference to FIGS. 1A-C. Second, that introduction leads into a description with reference to FIGS. 2A-B of some exemplary embodiments of a layered garden wall used in an exemplary SCGB. Third, with reference to FIGS. 3A-C, a bulkhead valve is described in application to exemplary SCGBs. Fourth, with reference to FIGS. 4-7B, the discussion turns to exemplary embodiments that illustrate air flows within an exemplary SCGB. Fifth, and with reference to FIGS. 8-9, this document describes exemplary apparatus and methods useful for manufacturing exemplary layered garden walls. Sixth, this disclosure turns to a discussion of control systems used in exemplary SCGBs with reference to FIGS. 10-18. Exemplary methods of active environment regulation are described with reference to FIGS. 19-22. Seventh, the document introduces a method to determine a coating composition and thickness with reference to FIG. 23. Finally, the document discusses further embodiments, exemplary applications and aspects relating to SCGB.

FIG. 1A, FIG. 1B, and FIG. 1C depict an exemplary Soil Controlling Gardening Box (SCGB) embodied as a Smart Automatic Gardening Box (SAGB) employed in an illustrative use-case scenario. For example, the SCGB may be used to grow vegetables and/or fruit above ground. A SCGB 100, as shown in FIG. 1A, includes a filling vent 105, a windcatcher tower 110, and coated walls 115. For example, one or more of the coated walls 115 may be constructed of Expanded Polystyrene (EPS) and coated with Polyurea (PU) (e.g., non-shrinking aliphatic polyurea) or Polyurethane. For example, the PU coating may provide structural support to the SCGB 100. In some implementations, the SCGB 100 may be advantageously light weight and durable.

Further discussion of various layers of the coated walls 115 is described with reference to FIGS. 2A-B. An example process for applying coating to the EPS is described with reference to FIGS. 8-9. Food safety and durability may, for example, be important considerations for making above ground gardens. Various embodiments may, for example, advantageously provide lightweight yet durable garden containers (e.g., the SCGB 100) using food safe materials.

In some implementations, the coated walls 115 may include an insulation value (R-value) determined by thickness and density of EPS or Polyurethane wall structure. For example, the R value per inch of the coated walls 115 may range between 5-7 based on density of the EPS and/or the polyurethane. In some implementations, the coated walls 115 may advantageously regulate soil temperatures to mimic ground temperatures in respective climate zones. With the flexibility to adjust the R value and U value (thermal conductivity) at the coated walls 115, for example, the SCGB 100 may be configured as an SAGB to adapt the garden for various temperatures (e.g., from extreme temperature changes external to the SCGB 100). Accordingly, the SCGB 100 may advantageously have a thermal R value selected for year-round plant growth, for example.

In some implementations, the SCGB 100 may include, as an SAGB, a gardening condition controller (GCC 120) to control various environmental variables in the SCGB 100. The environmental variables may, for example, include mechanical, electrical and soil, water, light, and/or heat that may affect plants growing in the SCGB 100. In some implementations, the GCC 120 may include a soil profile that predefines environmental conditions of the environmental variables for one or more target crops. In some examples, the GCC 120 may be configured to maintain a predetermined growing condition as a function of a target crops to be planted in the SCGB 100.

For example, the GCC 120 may include a proportional-integral-derivative (PID) controller. For example, the PID controller may include a feedback control mechanism to regulate and maintain a temperature, flow, pressure, speed and other process variables. In some implementations, the GCC 120 may include three components to adjust the control signal or output based on an error between a desired setpoint and an actual measured value. For example, a proportional control may generate an output proportional to the error. For example, the PID controller may include a higher proportional gain to generate a stronger corrective action. For example, the GCC 120 may include an integral control that may take into account an accumulated error over time. For example, the GCC 120 may integrate the error to generate continuously a control signal to eliminate any steady-state error. For example, the GCC 120 may include a derivative control to regulate a rate of change of the error. For example, the PID controller may generate a dampening control signal to prevent overshooting or oscillations in variable regulation. For example, the PID controller may continuously adjust a control signal to minimize the error and maintain system variables (e.g., temperature, humidity, electric potential) at a predetermined setpoint.

In some implementations, the SCGB 100 may include one or more wicking channels for the soil to wick the water from the bottom of the box to the soil on a continuous basis. For example, the wicking channels may be mechanically enhanced and/or electronically enhanced to maintain a constant control of moisture to the root zones of the plants.

In this example, the SCGB 100 includes a wicking bed (WB 125). The WB 125 includes one or more reservoirs 130. In some implementations the reservoirs 130 may be filled with water via, for example, the filling vent 105. In some examples, the reservoirs 130 may be a self-contained coarse material-filled subsoil reservoir. In some examples, the reservoirs 130 may include liquid solution of nutrients and processed water (e.g., filtered, treated). In various implementations, plants may use the WB 125 to receive water through capillary rise from the reservoirs 130. In some implementations, the reservoirs 130 may be filled manually or automatically with a water port 135. For example, the water port 135 may be operated by the GCC 120. For example, the water port 135 may control the water port 135 to adapt for different crop types and environmental settings (e.g., to control soil salinity). In some examples, rain and/or recycled wastewater may be used to fill the reservoirs 130.

In this example, the SCGB 100 includes a soil plate 140 to separate the WB 125 with a plant growing medium (PGM 141) (e.g., soil, plant growing solutions, nutrient solutions, growing substrates) on top. For example, the soil plate 140 may be a piece of EPS coated at both top and bottom with polyurea. In some implementations, the coated soil plate 140 may then be welded or otherwise coupled to the SCGB 100 with polyurea. In some implementations, the PGM 141 may be 300 mm in height and may be supported by the reservoirs 130 having 3-5 inches deep of water.

In some implementations, the SCGB 100 may include a clamshell cover 145 to protect plants, mushrooms, cannabis, the PGM 141 from outside forces (e.g., wind, rain, other climate events) and retain heat, moisture and positive forces within the garden that benefit growth. In this example, the clamshell cover 145 is two-sided. In some examples, the clamshell cover 145 may be single sided. In some implementations, other shapes of cover may be used in the SCGB 100. For example, a retractable cover may be used. For example, the clamshell cover 145 may be a dome cover. For example, the clamshell cover 145 may include a roller shutter.

For example, the clamshell cover 145 may be clear and/or opaque. For example, the clamshell cover 145 may be made in acrylic, polycarbonate, PET, or other suitable material determined by the climate zone and need of the garden.

In some implementations, the clamshell cover 145 may include one or more handle(s) 146 to operate manually. For example, a user may use the handle 146 to manually activate and deactivate the clamshell cover 145. In some implementations, integrated circuitry (IC) may be installed within the clamshell cover 145 to operate the clamshell cover 145 automatically. For example, the IC may be used for power storage, signaling, and grounding. In some examples, the clamshell material may be designed for radiation control (e.g., borated polyethylene). In some implementations, the clamshell cover 145 may include radiation control materials. For example, the clamshell cover 145 may include Ultra-violet radiation protection materials.

In this example, the clamshell cover 145 may be controlled by the GCC 120. For example, the GCC 120 may control a rotating hinge that connects the clamshell cover 145 to a body of the SCGB 100. For example, the GCC 120 may activate the clamshell cover 145 to sealingly enclose a plant growing volume in the SCGB 100.

As shown in FIG. 1A, the clamshell cover 145 includes a temperature sensor 148 and a wind sensor 147. For example, the GCC 120 may selectively activate the clamshell cover 145 as a function of a measured temperature and wind speed by the temperature sensor 148 and the wind sensor 147.

In some implementations, the windcatcher tower 110 may be configured to induce a passive, and/or to inject an active airflow in the WB 125 to advantageously overcome bacterial, pathogenic, parasitic, viral, and/or other build up in the WB 125. For example, the windcatcher tower 110 may be placed at an end of the SCGB 100. The SCGB 100 includes a connection pipe 112. As shown, the windcatcher tower 110 may include a wind catching cap at one end that is exposed to an external environment. For example, the windcatcher tower 110 may include another end that is connected to the WB 125.

In some implementations, the windcatcher tower 110 may move air in and out of the WB 125 by capturing wind 111 and/or utilizing a pressure differential between the WB 125 and an outside of the SCGB 100. Details and various embodiments of the windcatcher tower 110 are discussed further with reference to FIGS. 4-7B.

As shown in FIGS. 1B-C, the SCGB 100 includes support blocks 142 underneath the soil plate 140 to give structural support. For example, the support blocks 142 may be made of EPS. As shown in FIG. 1B, the support blocks 142 may include cutouts 185 at the bottom and top to allow water flow and air flow between chambers defined by the support blocks 142. For example, a wicking feature may be installed at the cutout 185 when a modular gardening box is assembled with the coated wall 115.

In some examples, the SCGB 100 may include draining holes (e.g., 1-4 inches wide) at each end of for entrance and exit of water to and from the WB 125. As shown in FIG. 1A, a bulkhead valve 160 is installed at the coated walls 115 to advantageously facilitate the water flow and the air flow between the chambers. The bulkhead valve 160 is described in further details with reference to FIGS. 3A-B.

In this example, the SCGB 100 includes a temperature sensors 155a, a conductivity sensor 155b, a moisture sensor 155c, and a water level sensor 155d to measure various conditions in the PGM 141, in the reservoirs 130, and/or in the air of the SCGB 100. For example, the sensors 155a-d may measure, for example, temperature, moisture, carbon dioxide (CO₂) level, oxidation reduction potential (ORP), acidity (pH), conductivity, organic matter level, and/or water level. In some implementations, the GCC 120 may actively manage conditions of the PGM 141 and environment inside the SCGB based on measurements received from the sensors 155a-d.

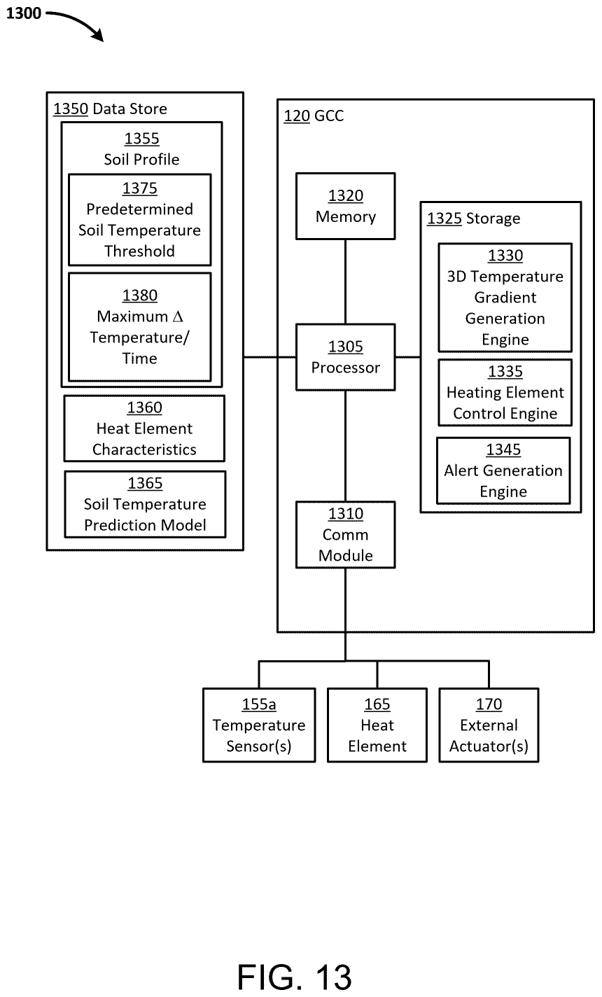

In this example, the SCGB 100 includes a heating element 165 installed/integrated into the coated walls 115. For example, the heating element 165 may be placed around the peripheral of the SCGB 100. For example, the heating element 165 may be embedded in the coated walls 115. For example, the heating element 165 may heat the soil to a predetermined temperature to facilitate growing of a plant. Further discussion of the heating element 165 and other components of a heating system of the SCGB 100 are described with reference to FIG. 13.

In some implementations, the heating element 165 may, for example, be integrated (e.g., laminated, or sandwiched) within the coated walls 115 of the SCGB 100 to heat the soil (e.g., within a volume bounded by the four coated walls 115.).

As shown, an exemplary schematic of the coated walls 115 is displayed in schematic view 180. For example, the coated walls 115 may include a thermal barrier layer 181 a coated on opposite sides with a protective layer 181b of quick curing material. For example, the 181b may be heat resistant. For example, the protective layer 181b may advantageously thermally separate the thermal barrier layer 181a from the heating element 165.

The SCGB 100 also includes a grounding system 150. For example, soil and plants may work synergistically to manage an electron pool for growth of the plants and health of the soil. In some implementations, the grounding system 150 may be configured to optimize the ground plane using conductivity to maximize the variant of plant life in soil for target (e.g., optimal) growth. For example, the impedance of the soil and the plant may both be regulated.

In some implementations, the materials of construction that make up the SCGB 100 may be highly resistive to earth ground. As shown in FIG. 1A, an inner shell and/or an outer shell of the SCGB 100 may be doped with a low power charge application device 170 allowing the collection and storage of energy in the form of an electrical charge that exhibits self-capacitance. Various implementations of the grounding system 150 may be possible. Some illustrative implementations may, by way of example and not limitation, include applying a negative DC charge to the inner shell and a positive DC charge to the outer shell. For example, the outer shell may be connected to an earth ground (e.g., an electric ground 151). For example, the electric ground 151 may be coupled to an electric ground of a building. For example, coupling the electric ground 151 to the building ground may advantageously keep discharging of electrical potential safe. For example, a lower grounding potential may be generated in the surrounding atmosphere and soil.

In some examples, the low power charge application device 170 may apply a positive DC charge at an inner shell and a negative DC charge to the outer shell. For example, the outer shell may be connected to earth ground to raise the grounding potential in the surrounding atmosphere and soil. For example, the low power charge application device 170 may apply a negative DC pulse with the outer shell grounded. For example, the low power charge application device 170 may apply a positive DC pulse with the outer shell grounded. For example, the low power charge application device 170 may apply a negative DC charge to the inner shell and a positive DC charge to the outer shell. For example, the grounding potential in the surrounding atmosphere and soil may be reduced. For example, additional electrodes are inserted in the soil to apply a negative DC pulse to the inner shell.

For example, the low power charge application device 170 may apply a negative DC charge to the inner shell and a positive DC charge to the outer shell. For example, the grounding potential in the surrounding atmosphere and soil may be lowered. In some implementations, additional electrodes may be inserted in the PGM 141 to apply a positive DC pulse to the inner shell.

For example, the low power charge application device 170 may apply a positive DC charge to the inner shell and a negative DC charge to the outer shell. For example, the grounding potential in the surrounding atmosphere and soil may be raised. Additional electrodes are inserted in the soil to apply a negative DC pulse to the inner shell. For example, the low power charge application device 170 may apply a positive DC charge to the inner shell and a negative DC charge to the outer shell. For example, the grounding potential in the surrounding atmosphere and soil may be raised. For example, additional electrodes are inserted in the soil to apply a positive DC pulse to the inner shell.

In some implementations, the grounding system 150 may digitally control an impedance path using pulse-width modulation (PWM) techniques. For example, the grounding system 150 may include a bipolar transistor. For example, the grounding system 150 may include a field effect transistor (FET). In some implementations, the grounding system 150 may run a transistor in a linear mode (e.g., as a class A, class B, and/or class AB amplifier). For example, the DC pulse may be applied using the PWM technique.

In this example, the GCC 120 is connected to external actuator(s) 175. For example, the external actuator(s) 175 may include a communication module. For example, the communication module may include a wireless network module. In some implementations, the wireless network module may be connected to the Internet. In some implementations, the external actuator(s) 175 may include other devices. For example, the external actuator(s) 175 may include an external irrigation system. For example, the external irrigation system may be activated when the water level in the reservoirs 130 is low.

As shown, the water level sensor 155d is measuring a fill level in the reservoirs 130. For example, the moisture sensor 155c is measuring a moisture level of the PGM 141. In various implementations, the GCC 120 may use the water level sensor 155d and the moisture sensor 155c to measure a moisture level of the plant growing medium. For example, the GCC 120 may control a moisture level of the PGM 141 by comparing a level measurement of the water level sensor 155d and a rate of change of the moisture level of the PGM 141 to a soil profile stored in the GCC 120. For example, the GCC 120 may generate a signal as a function of the level measurement and a minimum threshold specified in the soil profile.

In some implementations, the moisture sensor 155c may be a pH sensor. For example, a number of free anions and/or cations may affect a dielectric constant of the PGM 141. For example, having loose anions/cations in the PGM 141 may affect resistivity. For example, the moisture sensor 155c may measure capacitance, resistivity, and/or pH to generate a moisture measurement.

As shown, the temperature sensors 155a are disposed throughout the SCGB 100 (as shown by the dashed line). For example, the temperature sensors 155a may be disposed in at least at each side and at a bottom of the SCGB 100. In some implementations, the GCC 120 may use the temperature sensors 155a to control a temperature of the PGM 141. For example, the GCC 120 may generate a 3D temperature matrix of the PGM 141. For example, the 3D temperature matrix may be generated by interpolating temperature measurements in each of the locations corresponding to the temperature sensors 155a. The 3D temperature matrix, for example, may be compared to a threshold matrix defined in the soil profile of the GCC 120. For example, the GCC 120 may generate a temperature control signal as a function of the compare result. In some implementations, the heating element 165 may be activated by the temperature control signal. For example, the heating element 165 may be controlled to regulate the temperature of the PGM 141 using the temperature control signal. In various implementations, the GCC 120 may generate the temperature control signal such that the heating elements supply thermal energy to the plant growing medium such that a rate of change in a soil temperature is less than or equal to a maximum rate specified in the soil profile.

In this example, the grounding system 150 is coupled to the GCC 120 to actively control an impedance of the PGM 141 in the SCGB 100. For example, the GCC 120 may generate a control signal to regulate the grounding system 150 to adjust an impedance of the PGM 141 from the low power charge application device 170 to the electrical ground. In some implementations, the GCC 120 may monitor an electrical potential in the PGM 141 based on measurements from the conductivity sensor 155b (e.g., a potential sensor, a graphene electric field sensor). In some implementations, the GCC 120 may compare the electrical potential in the PGM 141 to a target range of electrical potential as a function of a predetermined rate of ions flow specified in the soil profile. Based on the comparison, the GCC 120 may, for example, generate a control signal to the grounding system 150 to control the low power charge application device to adjust a current flow in the PGM 141.

In various implementations, the SCGB 100 may include a cover (e.g., the clamshell cover 145) releasably coupled to a body of the SCGB 100. For example, the cover may shield materials in the GCCS from external weather conditions. For example, the cover may be activated by a controller (e.g., the GCC 120). For example, once activated, the cover may sealingly enclose the SCGB 100.

In various implementations, the SCGB 100 may include a flow inducing channel (e.g., the windcatcher tower 110) fluidly connected to the liquid reservoir in one end and exposed to ambient air in the other end. For example, a pressure differential between an external environment of the SCGB 100 and the liquid reservoir 130 may induce an airflow between the external environment and the liquid reservoir.

FIG. 2A and FIG. 2B are side cross-section views of an exemplary SCGB showing a close-up diagram of exemplary layers of a layered garden wall. As shown, the layered garden wall 200 (e.g., the coated walls 115) may include a sandwich structure having hybrid materials. In some implementations, the layered garden wall 200 may integrate layers of various functions. In some examples, the layered garden wall 200 may form at least part of the coated wall 115 in FIG. 1A.

In this example, the layered garden wall 200 includes an inner PU layer 205, a heat trace layer 210, a reflective layer 215, an EPS layer 220, and an outer PU layer 225. In some implementations, the heat trace layer 210 may include a mixture of carbon and/or copper. In some examples, the heat trace layer 210 may include a graphene heat trace. In some examples, the reflective layer 215 may be made of aerogel and/or other insulating materials. For example, the aerogel in the reflective layer 215 may advantageously prevent fire caused by overheating at the EPS layer 220. In some implementations, various layers of the layered garden wall 200 may be formed using lamination techniques, such as sandwich panels.

In some implementations, the heat trace layer 210 may generate heat by resistive heat gain. For example, the generated heat may be transferred to the PGM 141 by infra-red (IR) heating. Some examples of heat trace materials suitable for the heat trace layer 210 includes Nichrome wire, carbon as a conductor, polyimide, copper, graphene, carbon paint, or graphene paint. In some implementations, the heat trace layer 210 may include laminated siliconized rubber with a carbon core configured to operate at lower temperatures (e.g., below 200 Celsius). In some implementations, the heat trace layer 210 may include carbon or graphene sheets with low power input to, for example, use an infrared spectrum to produce heat.

As shown in FIG. 2B, an exemplary garden wall 230 includes a thermal barrier layer 235. For example, the thermal barrier layer 235 may include EPS. For example, the thermal barrier layer 235 may include cork. For example, the thermal barrier layer 235 may include other insulating structures. The exemplary garden wall 230 includes an outer protective layer 240a and an inner protective layer 240b coated on opposite sides of the thermal barrier layer 235. For example, the inner protective layer 240b may be inward facing. For example, the inner protective layer 240b may be in contact with the PGM 141. For example, the outer protective layer 240a may be in contact with an external environment of the SCGB 100. For example, the protective layers 240a-b may be heat resistant. For example, the protective layers 240a-b may include aromatic polyurea. For example, the protective layers 240a-b may include aliphatic polyurea. For example, the aromatic polyurea may include an application temperature of 160-180° F. For example, the aliphatic polyurea may advantageously cure quicker than polyurea. For example, a polyurethane may also be used as the protective layer 240a, 240b. For example, the polyurethane may include a less extreme application temperature of 125-130° F. In various implementations, the protective layers 240a-b may be quick curing that cures within 10 seconds after application. In some implementations, the protective layers 240a-b may include a material hardness between shore durometers between 25 D and 60 D.

The exemplary garden wall 230 includes an aerogel putty layer 245 (e.g., the reflective layer 215). The exemplary garden wall 230 also includes a heat source layer (HSL 250). In some implementations, the HSL 250 may be disposed at an outer surface of an inner coating (e.g., the aerogel putty layer 245). For example, the HSL 250 may be between the aerogel putty layer 245 and an inner protective layer 240b. For example, the protective layer 240b may thermally separate the thermal barrier layer 235 from the thermal energy generated by a heating element (e.g., the HSL 250). For example, the HSL 250 may include siliconized rubber with carbon or graphene. For example, the HSL 250 may include infrared carbon sheets. For example, the HSL 250 may include nichrome wire. In some implementations, the exemplary garden wall 230 may include the 245 on both sides of the thermal barrier layer 235 to thermally separate the thermal barrier layer 235 from an outside heat source. The exemplary garden wall 230 includes a conductive layer 255. For example, the conductive layer 255 may include copper. For example, the conductive layer 255 may include aluminum. In some examples, the HSL 250 may be integrated with the inner protective layer 240b. In some examples, the HSL 250 may be separated from the inner protective layer 240b. In some implementations, the protective layers 240a-b may include graphite. For example, the protective layers 240a-b may include borate. The graphite and/or borate may advantageously increase heat resistance of the exemplary garden wall 230.

FIG. 3A depicts an exemplary bulkhead valve 300. For example, the bulkhead valve 300 may be installed in the SCGB 100 as described as the bulkhead valve 160 in FIG. 1A. In some implementations, the bulkhead valve 300 may be configured to couple across a wall thicker than 2 inches.

FIGS. 3B-C are schematic diagrams showing orthogonal cross-section views of the exemplary bulkhead valve 300 as described with reference to FIG. 3A. As shown, the bulkhead valve 300 may include a valve that controls water flow. In some implementations, the bulkhead valve 300 may be installed at both ends of short sides of the SCGB 100. For example, the bulkhead valve 300 may be used for entrance and exit of water to and from the WB 125. FIG. 3B is a schematic diagram showing a cross-section view of the exemplary bulkhead valve 300 as described with reference to FIG. 3A. As shown, the bulkhead valve 300 is coupled to the coated walls 115 by fastening internal module 305 and an external module 310 together.

In some implementations, the internal module 305 and the external module 310 may include a sealing member 315 and engagement features 320. For example, when the engagement features 320 of the internal module 305 and the external module 310 may be registered and engaged with each other in one direction. For example, the internal module 305 may be prevented from moving away from the external module 310. For example, the internal module 305 and the external module 310 may be coupled with ratcheting. For example, the engagement features 320 may include a interlocking teeth. For example, the engagement features 320 may include a grip tie. For example, the engagement features 320 may be deformed upon engaging with each other.

In some implementations, the sealing member 315 may include an O-ring. For example, the sealing member 315 may be configured to press against a wall (e.g., the coated walls 115) to prevent leaking. In some examples, the sealing member 315 may include a low durometer material (e.g., <Shore A 20).

FIG. 4 shows air flows within an exemplary SCGB using an exemplary windcatcher tower. The SCGB 100 includes two bulkhead valves 300 at each side in this example. For example, the bulkhead valves 300 may be installed just below the base of the soil plate 140, as shown in FIG. 3B. As shown, air moves in and out of the WB 125 through the bulkhead valves 300. The windcatcher tower 110, for example, may be passively or actively operated. For example, the windcatcher tower 110 may facilitate the movement of air by allowing pressure and temperature differentials between the WB 125 and the outside of the SCGB 100 to enhance the air movement. For example, the enhanced air movement may advantageously avoid water in the WB 125 and the PGM 141 from becoming stagnant. In some examples, the air movement may also assist in regulating soil and water temperature. In some implementations, a top of the windcatcher tower 110 may be removable to allow the pipe of the windcatcher tower 110 to become a fill port for water or other inputs to the WB 125.

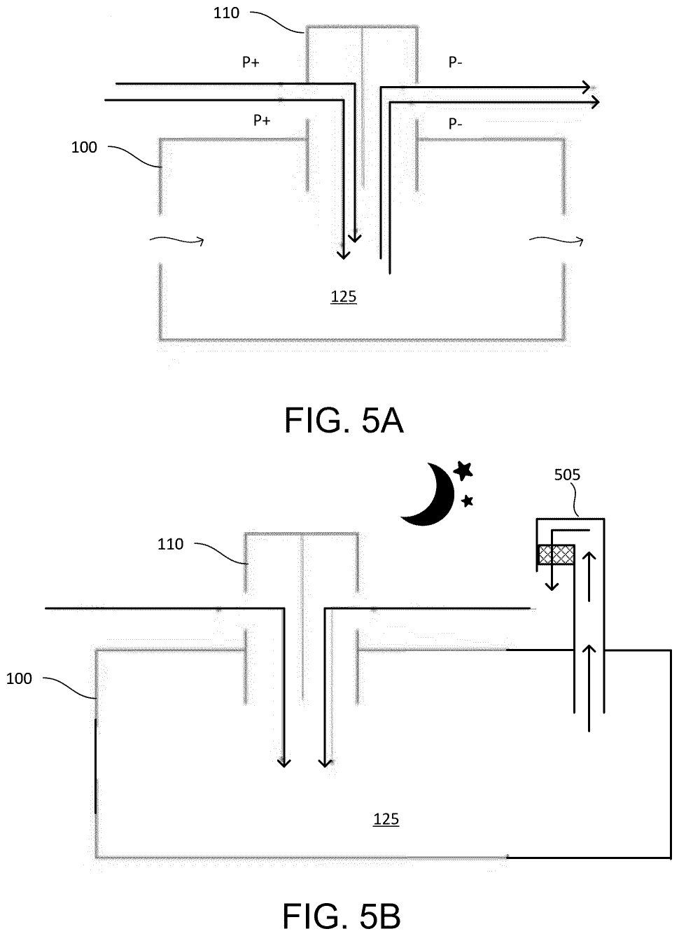

FIG. 5A is a schematic diagram showing air flows in an exemplary SCGB 100 based on a pressure difference in a first embodiment. In this example, the windcatcher tower 110 may induce air exchange within the SCGB 100 by driving high pressure air into the SCGB 100 and allowing air within the SCGB 100 to flow out at a side with lower air pressure. For example, the exchange of air may advantageously control undesirable bacteria and parasites in the WB 125. Accordingly, the SCGB 100 may provide healthier water for the PGM 141 and plants.

FIG. 5B is a schematic diagram showing air flows in an exemplary SCGB based on a pressure difference in a second embodiment. In this example, the SCGB 100 includes a fill vent 505. The fill vent 505 fluidly connects an outside environment to the WB 125.

As shown, in the night-time, a cooler temperature outside of the SCGB 100, creating lower pressure, may induce air to be flowing out through the fill vent 505. The windcatcher tower 110 may drive, in this example, outside air into the SCGB 100.

In some implementations, the air flow (as shown in FIGS. 5A-B) may be measured with a self-heating silicon device (SHSD). For example, more than one SHSD may be arranged in a bridge formation.

For example, one sensor (e.g., a SHSD) may be placed in static air. One sensor (e.g., a SHSD) may be placed in flowing air. For example, time may be exchanged between the measurement between the two sensors (e.g., the two or more SHSDs) to generate a differential signals to remove a noise floor.

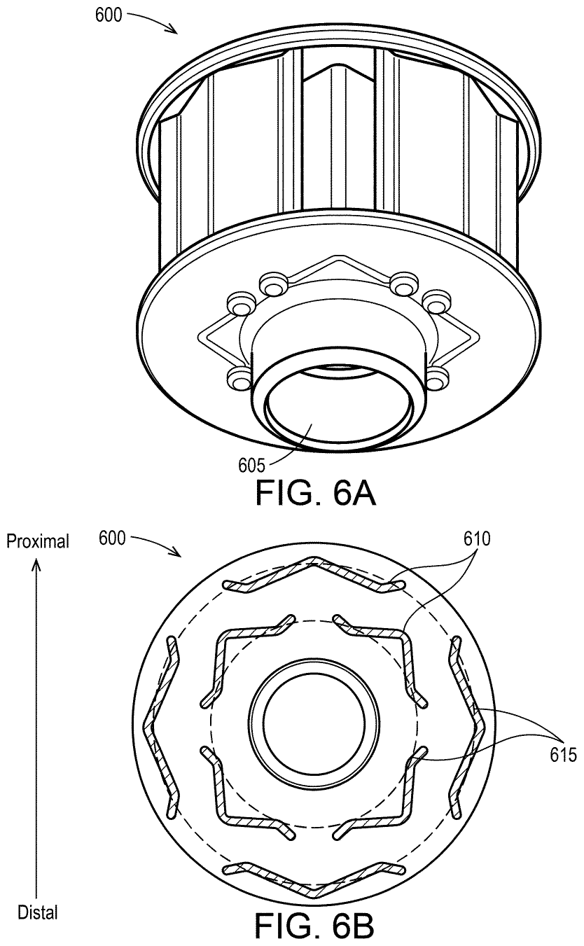

FIG. 6A and FIG. 6B show a perspective view and a bottom view, respectively, of an exemplary windcatcher tower cap (WTC 600). As shown in FIGS. 5A-B, the WTC 600 may be coupled to a connection pipe fluidly connected to the liquid reservoir. For example, the WTC 600 may be disposed vertically above the reservoirs 130. For example, the WTC 600 may be exposed to an external environment and ambient air. In some examples, as described in FIG. 5A, a pressure differential between the ambient air and the reservoirs 130 may induce an airflow between the external environment and the liquid reservoir through the WTC 600.

For example, the WTC 600 may be releasably coupled to a connection pipe of the windcatcher tower 110 through a pipe connection element 605. Dimensions are for illustration purposes only. Other dimensions may also be possible, in some implementations. For example, outside air may be fluidly received through the pipe connection element 605.

As shown in FIG. 6B, the WTC 600 includes two rings of eight fin elements 610. For example, the eight fin elements 610 may be arranged in two rotating rings 615. For example, the two rotating rings 615 may be concentrically disposed. For example, when an air flow reaches the WTC 600 at a proximal side. For example, the two rotating rings 615 may be induced to rotate in a clockwise direction viewing from above. For example, air flow may be induced to flow into the proximal side of the flow inducing feature towards the liquid reservoir through the connecting pipe. In some implementations, a pressure within the reservoirs 130 may increase and induce air within the reservoirs 130 to flow towards a distal side of the WTC 600.

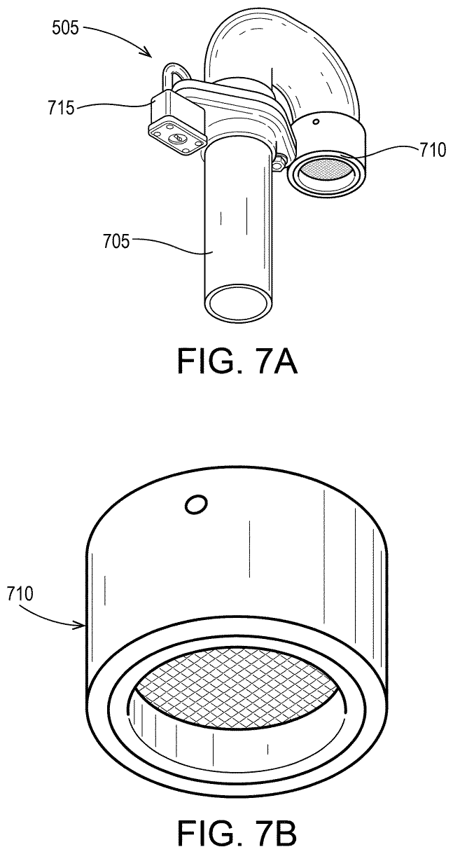

FIG. 7A shows an exemplary fill pipe. In this example, the fill vent 505 may be releasably coupled to a fill pipe 705. In some implementations, when the fill vent 505 is removed, water or other inputs may be filled (e.g., poured) into the WB 125 using the fill pipe 705. When the fill vent 505 is releasably coupled to the fill pipe 705, air and other fluid may be vented out from the fill vent 505 to advantageously relieve pressure accumulated within the WB 125. In some implementations, the fill vent 505 may also allow intake of air at one end of the SCGB 100 while air is removed through the windcatcher tower 110.

As shown, the fill vent 505 is U-shaped. For example, the U-shape vent may prevent unauthorized liquid from entering the reservoirs 130. The fill vent 505, in this example, is secured to the fill pipe 705 using a lock 715. For example, the lock 715 may advantageously prevent unauthorized removal (e.g., to gain unconsented access of the reservoirs 130) of the fill vent 505.

FIG. 7B shows an exemplary vent screen configured to be coupled to the fill vent described with reference to FIG. 7A. In some implementations, the vent screen 710 may advantageously prevent pests and/or other undesirable objects from entering the SCGB 100. For example, the vent screen 710 may include a mesh such that objects are prevented from entering the reservoirs 130.

FIG. 8 is a graph showing an exemplary temperature profile 800 at an exemplary gardening wall during an exemplary coating application process. For example, the coating application process may apply PU resins (e.g., JEFFAMINE® (Polyetheramines), SUPRASEC® (Low-functional Isocyanate Pre-polymer), JEFFLINK® 754 (Aliphatic Chain Extender), UNLINK® 4200 (Aromatic Chain Extender). For example, a polyurea spray elastomer system formulated with these ingredients are 100 percent two-component solids which are extremely reactive with cure times as short as 3-5 seconds.

Polyurea have very low water permeability, which makes these resins ideal for moisture barrier applications. For example, a polyurea spray coatings used in the coating application process may provide very fast cure even at temperature extremes of about 0° F. and up to +450°-300° F. For example, the polyurea or polyurethane coating is a fast cure (6-20 seconds) at a high temperature (130-170° F.). In various examples, coating applied may be approved by health authorities (e.g., the U.S. Food and Drug Administration (FDA)) to advantageously provide safety food growing out of the SCGB 100.

In this example, the coating application process begins at time t0. For example, the coating application process may apply a coating (e.g., a PU coating) at the EPS layer 820. In some implementations, PU coating may be applied at the same time at both sides 805, 825 of the EPS layer 820. The coating application process applies a high temperature (e.g., 450° F.) from t0 to t1. As shown, a temperature increases during t0 to t1 in the inner PU layer and the outer PU layer region. In some implementations, the EPS layer 820 may have a predetermined deformation temperature of Td_EPS. After the PU coating is applied, for example, temperature may propagate into the EPS layer 820 from t1 to t2. In some examples, the cure time is around 6-20 s based on properties of the PU coating. As shown, in this example, because t2−t1 is small, temperature within the EPS layer 820 may be kept below Td_EPS.

In some implementations, the PU coating may include a quick setting time. For example, the PU coating may include an excellent abrasion and scratch resistance. For example, the PU coating may include a very durable resistance to weather and environmental conditions. For example, the PU coating may include very beneficial elongation properties. For example, the PU coating may be applied in extreme temperature conditions as high as 450° F. before deformation of the EPS. For example, the PU coating may be regulated finely to control coating thickness. For example, the PU coating may include a very effective bonding on correctly prepared surfaces of wood, cement, concrete and metals and expanded polystyrene. For example, the PU coating may include a superior chemical resistance. For example, the PU coating may include feasibility of low viscosity. For example, the PU coating may be formulated for a very high tensile strength

FIG. 9 is a flowchart illustrating an exemplary layered garden wall manufacturing method 900. For example, a user may use the exemplary layered garden wall manufacturing method 900 to manufacture one or more panels of the layered garden wall 200 as described in FIG. 2A. In this example, the 900 begins when a thermal barrier layer is provided in step 905. For example, the thermal barrier layer 235 may include la predetermined deformation temperature. In a decision point 910, it is determined whether an end product of the exemplary layered garden wall manufacturing method 900 is a soil plate (e.g., the soil plate 140 in FIG. 1A). If it is not a soil plate, in step 915, a heat trace layer is disposed on an inner side of a reflective layer. For example, the HSL 250 may be disposed on an inner side of the aerogel putty layer 245. If it is a soil plate, in step 920, at least one cutout hole (e.g., the cutout 185) is made on the thermal barrier layer, and the step 915 is repeated.

After the heat trace layer is disposed, in step 925, a reflective layer is disposed on at least one side of the thermal barrier layer to create a core layer. For example, the reflective layer 215 may include a thermal insulating material. For example, the reflective layer 215 may include aerogel. For example, the core layer may include the thermal barrier layer, the reflective layer, and the heat trace layer. In step 930, a protective coating with q quick curing time (e.g., less than 10 seconds) is applied to the core layer for a predetermined application duration, and the method 900 ends.

For example, the inner PU layer 205 (e.g., the outer protective layer 240a) may include polyurea resins. For example, the inner PU layer 205 may be applied at a high temperature higher or equal to the predetermined deformation temperature (e.g, higher than 120° F.). For example, the inner PU layer 205 may include polyurea spray coating. For example, the inner PU layer 205 may include polyetheramines. For example, the inner PU layer 205 may include a low-functional isocyanate pre-polymer. For example, the inner PU layer 205 may include aliphatic chain extender. For example, the inner PU layer 205 may include aromatic chain extender. For example, the inner PU layer 205 may include a curing time that summation of the predetermined application duration and the curing time is less than a thermal propagation time for a temperature of the core layer to rise above the predetermined deformation temperature. Accordingly, for example, the temperature of the thermal barrier layer may advantageously be kept below the predetermined deformation temperature throughout the coating application process.

FIG. 10 is a block diagram showing an exemplary gardening condition controller (GCC 1000). In this example, the GCC 120 includes one or more garden pod sensors 1005, a control panel 1010, and a weather station 1015. As shown, the garden pod sensors 1005 may measure data from the WB 125, the PGM 141, and an environment surrounding the SCGB 100.

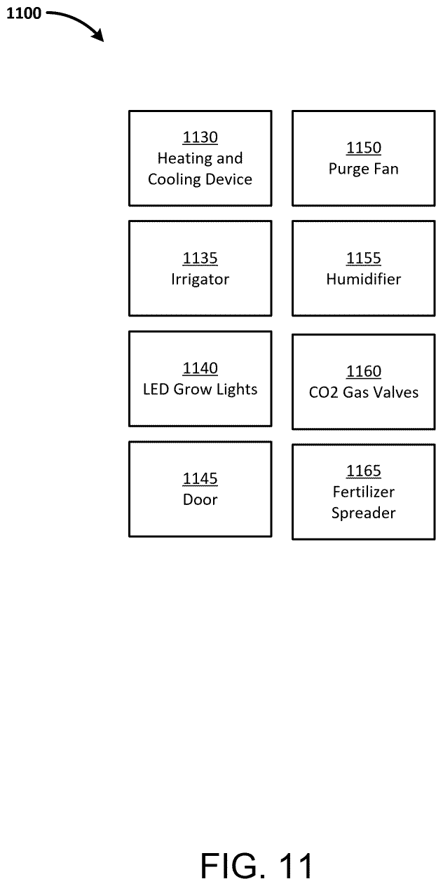

The control panel 1010 is operably coupled to the sensors 1005. In some implementations, the control panel 1010 may also be operably coupled to one or more output actuators (e.g., the external actuator(s) 175) to control one or more parameters of the SCGB 100. Some examples of the output actuators are shown in FIG. 11.

The control panel 1010, in this example, is connected to a solar panel 1020 to receive solar power. In some examples, the control panel may be connected to other power sources to receive power. For example, the control panel may receive power from a battery. For example, the control panel may be connected to a main power grid to receive A.C. power.

The control panel 1010, in some implementations, may include a global positioning system (GPS) to determine a current location of the SCGB 100, and/or collect local data. For example, the control panel 1010 may use the current location to determine a forecast of weather in next few hours. The control panel 1010 may also include a communication capability, for example, including MQ Telemetry Transport (MQTT) protocol and others, to communicate to a smart home, and/or communicate to a mobile device.

The control panel 1010 is, in this example, operably coupled to the weather station 1015. For example, the weather station 1015 may be a local weather station purposely built for providing local weather information to the control panel 1010. In some implementations, the weather station 1015 may be a remote weather station that may be accessed via an application programming interface (API) to retrieve local weather information.

FIG. 11 is a block diagram of exemplary external actuators (e.g., the external actuator(s) 175) used in a GCC as described with reference to FIG. 10. The garden pod output control equipment 1100 includes a heating and cooling device 1130, an irrigator 1135, a light emitting diode (LED) grow light 1140, a door 1145, a purge fan 1150, a humidifier 1155, CO2 gas valves 1160, and a fertilizer spreader 1165. For example, the heating and cooling device 1130 may be used to control heating and cooling cycles of the PGM 141 to maintain root temperature. The irrigator 1135 may include a control to the bulkhead valve 160 to refill the reservoirs 130. The light 1140 may include grow light controlled as a function of a measured solar flux density (per a period of time).

In some implementations, the door 1145 may be used to shelter the plants in the SCGB 100. For example, the door 1145 may be closed when the weather station 1015 forecast a temperature dropping below a preset temperature. For example, the door 1145 may be closed when wind speed is above a preset threshold. For example, the door 1145 may be closed when a barometric pressure begins to drop at a rate indicating an approaching storm.

For example, the purge fan 1150 may be turned on when CO2 level is above a preset threshold. For example, the humidifier 1155 may be turned on to water the plants when humidity is below a threshold. For example, the gas valves 1160 may be controlled based on CO2 level.

In some implementations, the fertilizer spreader 1165 may add physical compost to make up mature tea, add worms to improve soil texture, add biochar to facilitate microbe habitats, acidification of the soil to promote growth, add mycorrhizal fungi to increase root growth, top off soil with a layer of mulch to retain moisture, or a combination thereof.

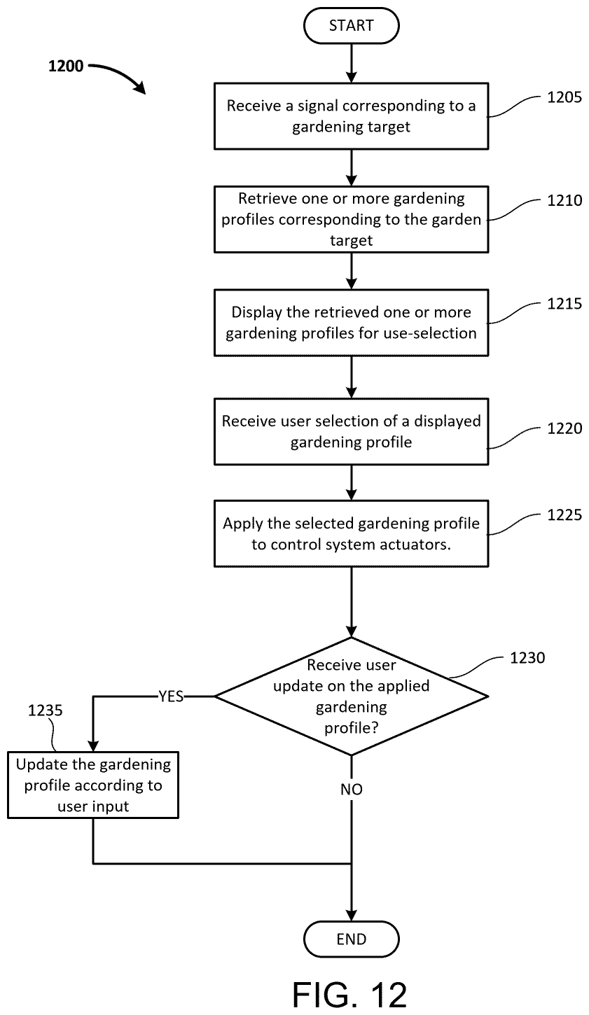

FIG. 12 is a flowchart illustrating an exemplary smart automatic gardening method 1200. For example, the smart automatic gardening method 1200 may be performed by the GCC 120. The smart automatic gardening method 1200 begins when a signal corresponding to a gardening target is received in step 1205. For example, the GCC 120 may receive a signal from a user device running an application via a communication module. In some examples, the gardening target may be a type of vegetable.

After receiving the signal, in step 1210, one or more gardening profiles corresponding to the garden target is retrieved. For example, the GCC 120 may retrieve the gardening profiles from a local or a remote storage device. The gardening profile, for example, may detail a target variant of the gardening target. For example, the variant may include various properties of the gardening target including, as an example without limitation, nutrient level, taste, resistivity to pests, and durability after harvest. In some implementations, the gardening profile may include detailed parameters at different time-periods of plant growth for achieving the various properties of the vegetable.

Next, the retrieved one or more gardening profiles are displayed for use-selection in step 1215. For example, the gardening profiles are displayed on the user device. In step 1220, a user selection of a displayed gardening profile is received. After the selection is received, in step 1225, the selected gardening profile is applied to control system actuators. For example, the GCC 120 may update the soil profile to control various actuators according to the user selected gardening profile. By applying the selected gardening profile, the GCC 120 may advantageously control the SCGB 100 to grow plants for example larger, more quickly, or to produce better fruit, for example.

Next, it is determined whether a user update is received on the applied gardening profile in step 1230. For example, the user may change one or more parameters of the selected gardening profile to fit personal taste. If it is determined that a user update is received on the applied gardening profile, in step 1235, the gardening profile is updated according to user input and the method 1200 ends. For example, the GCC 120 may update the soil profile of the changed parameters. If it is determined that no user update is received on the applied gardening profile, the method 1200 ends.

FIG. 13 is a block diagram depicting an exemplary soil temperature regulation system of an exemplary assistive gardening pod (AGP 1300). In this example, the AGP 1300 (e.g., the SCGB 100) includes the GCC 120. The GCC 120 includes a processor 1305. The processor 1305 may, for example, include one or more processors. The processor 1305 is operably coupled to a communication module 1310. The communication module 1310 may, for example, include wired communication. The communication module 1310 may, for example, include wireless communication. In the depicted example, the communication module 1310 is operably coupled to the temperature sensors 155a, the heating element 165, and the external actuator(s) 175.

The processor 1305 is operably coupled to a memory module 1320. The memory module 1320 may, for example, include one or more memory modules (e.g., random-access memory (RAM)). The processor 1305 includes a storage module 1325. The storage module 1325 may, for example, include one or more storage modules (e.g., non-volatile memory). In the depicted example, the storage module 1325 includes a 3D Temperature Gradient Generation Engine (3DTGCE 1330), a heating element control engine (HECE 1335), and an alert generation engine (AGE 1345). For example, the 3DTGCE 1330 may generate a 3D temperature matrix of the plant growing medium based on input received from the temperature sensors 155a. For example, the 3D temperature matrix may be generated by interpolating temperature measurements of the temperature sensors 155a at each sensor location.

The processor 1305 is further operably coupled to the data store 1350. The data store 1350, as depicted, includes a soil profile 1355, heat element characteristics 1360, and a soil temperature prediction model 1365. As shown, the soil profile 1355 includes a predetermined soil temperature threshold 1375. For example, the predetermined soil temperature threshold 1375 may include multiple temperature thresholds for different plants at different grow stages. For example, the predetermined soil temperature threshold 1375 may include a matrix of temperature thresholds.

In some implementations, the HECE 1335 may compare the 3D temperature matrix to the predetermined soil temperature threshold 1375 of the soil profile 1355. For example, the HECE 1335 may generate a temperature control signal as a function of the compare result. For example, the temperature control signal may be used to control the heating element 165. In some implementations, the HECE 1335 may generate the temperature control signal as a function of a predicted weather condition (e.g., received from the weather station 1015). In some implementations, the AGE 1345 may generate an alert to a user to notify an abnormal temperature in the SCGB 100. For example, the AGE 1345 may generate the alert based on the soil temperature prediction model 1365.

In this example, the soil profile 1355 includes a maximum rate of temperature change 1380 of the plant growing medium. For example, the maximum rate of temperature change 1380 may be plant dependent. For example, the HECE 1335 may generate the temperature control signal as a function of the maximum rate of temperature change. For example, the HECE 1335 may control the heating element 165 so that thermal energy supplied to the PGM 141 may be less than or equal to the maximum rate of temperature change 1380. For example, the HECE 1335 may forecast the change in the soil temperature based on the heat element characteristics 1360 and the soil temperature prediction model 1365.

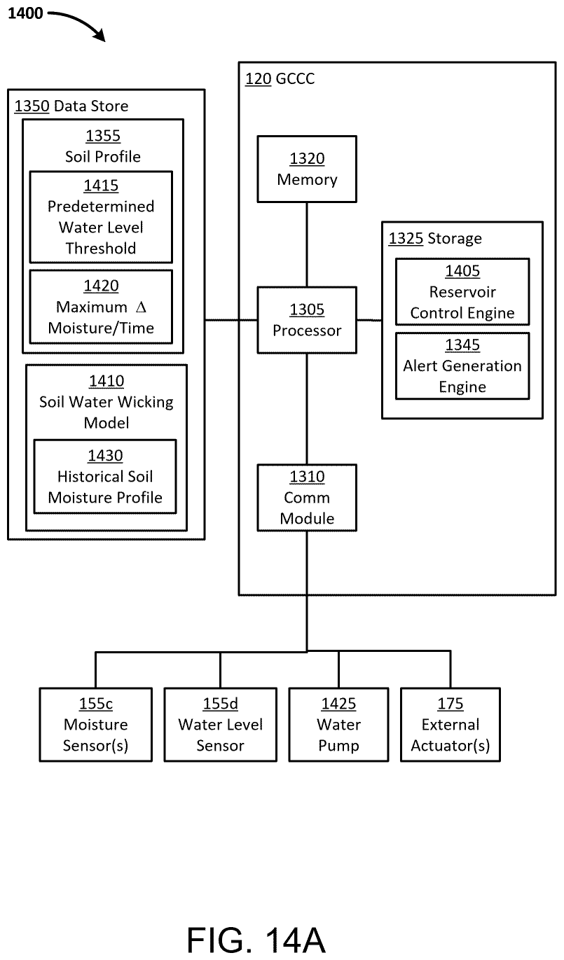

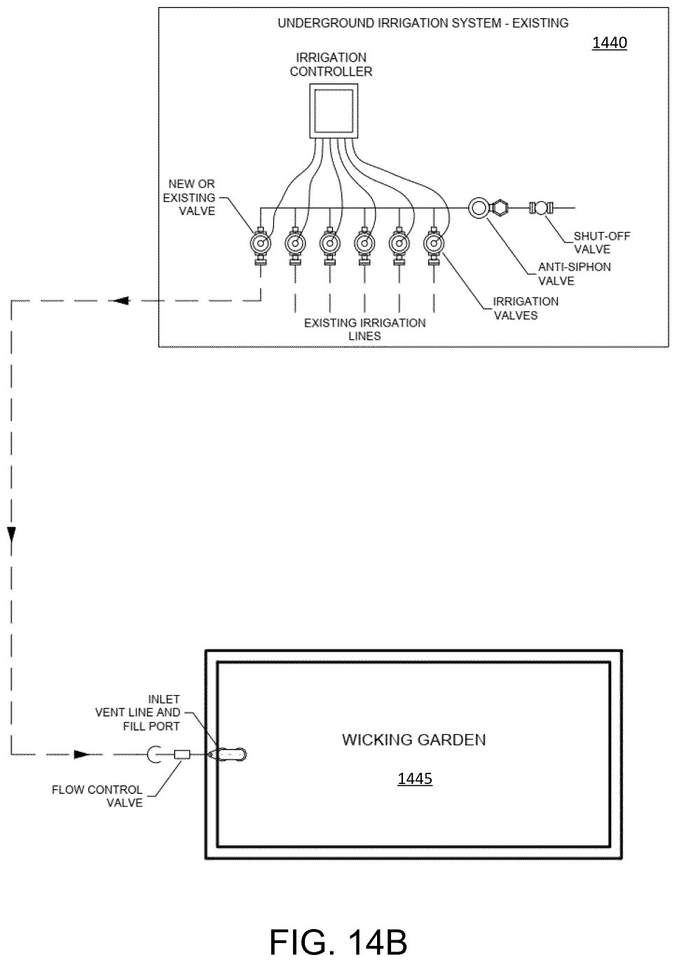

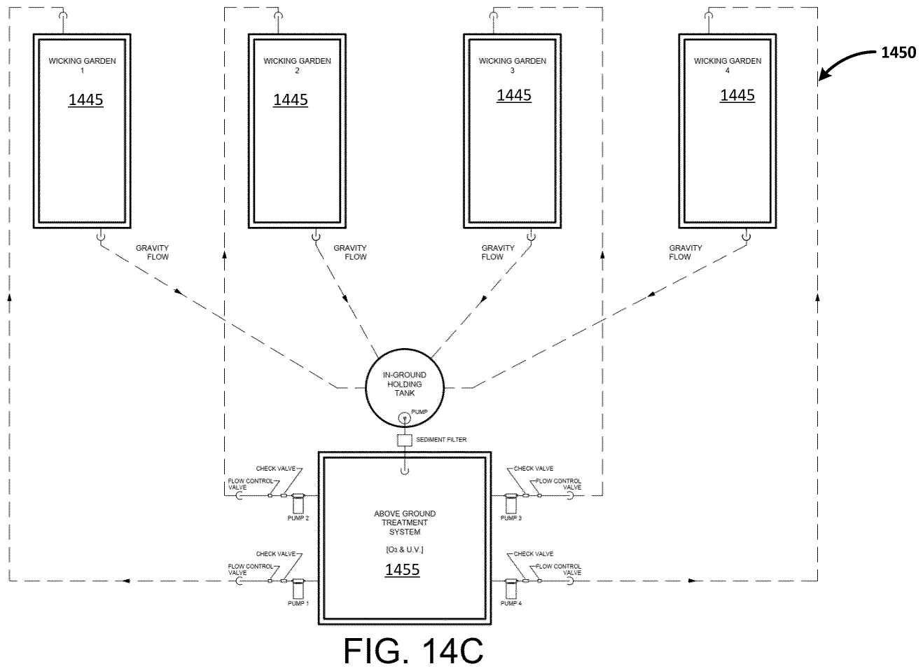

FIG. 14A is a block diagram depicting an exemplary soil moisture regulation system 1400 of an exemplary AGP. In this example, the communication module 1310 is operably connected to the moisture sensor 155c, the water level sensor 155d, a water pump 1425, and the external actuator(s) 175. The storage module 1325 includes a reservoir control engine (RCE 1405) and the AGE 1345. The data store 1350 includes the soil profile 1355 and a soil water wicking model 1410. The soil profile 1355 includes a predetermined water level threshold 1415 and a maximum rate of moisture change 1420.

In some implementations, the RCE 1405 may regulate a moisture level of the plant growing medium by comparing a soil moisture profile comprising a level measurement of the fill level sensor and a rate of change of the moisture level of the plant growing medium to the soil profile 1355. For example, the RCE 1405 may generate the soil moisture profile using measurements from the moisture sensor 155c and the water level sensor 155d. For example, a soil moisture is generated by measuring soil resistivity. In some implementations, the RCE 1405 may generate a three-dimensional moisture profile of the plant growing medium as a function of measurements from the multiple moisture sensors 155c.

As an illustrative example without limitation, the RCE 1405 may compare a current water level to the predetermined water level threshold 1415. If the water level is too low, then the RCE 1405 may generate a signal to the water pump 1425 (e.g., via the water port 135 and the bulkhead valve 160) to refill the reservoirs 130. In some implementations, the RCE 1405 may determine a rate of the refilling based on the maximum rate of moisture change 1420 and the soil water wicking model 1410. For example, the RCE 1405 may be configured to prevent over moisture (to prevent damage to crops). In some implementations, the soil water wicking model 1410 may predict a moisture level of the PGM 141 based on a rate of change of the water level and a current moisture level of the PGM 141. For example, the soil water wicking model 1410 may be used to generate a predicted wicking rate of the plant growing medium. For example, the soil water wicking model 1410 may include a historical soil moisture profile 1430. For example, the RCE 1405 may generate a control signal as a function of the soil water wicking model 1410 and the maximum rate of moisture change 1420 so that the moisture of the soil is kept below a predetermined level. For example, the control signal may include an alert signal to notify a user to refill the liquid reservoir generated by the AGE 1345.

FIG. 14B and FIG. 14C are block diagrams depicting exemplary water supply systems configured to supply one or more SCGBs. As shown in FIG. 14B, an existing underground irrigation system 1440 (e.g., such as common for suburban homes) may be connected as an economical way of adding water to a modular wicking garden. In the depicted examples, a standalone Wicking Garden 1445 (e.g., the SCGB 100) may, for example, include a manual fill port and/or vent line to add water. The standalone Wicking Garden 1445 may, for example, be tapped to automatically fill water from an existing water source (e.g., by an irrigation controller, by a controller of the SCGB 100). By adding water automatically to the Wicking Garden 1445, for example, water may advantageously be available (e.g., always) for the garden plants.

In the depicted example, a separate irrigation valve along with a flow control valve are provided. The flow may, for example, be predetermined. For example, an Irrigation Controller (e.g., of an irrigation system of the SCGB 100) may, for example, be set to operate a certain amount of time to add just enough makeup water daily or every other day to maintain a water level in the Wicking Garden (e.g., SCGB 100). In this example, a single controller may, for example, advantageously automatically provide water to multiple SCGB 100 units.

As depicted in FIG. 14C, a water conditioning and/or treatment system 1450 may modify fluid before distribution to one or more standalone Wicking Garden 1445. For example, an above ground treatment system 1455 may remove contaminants, add nutrients, or some combination thereof before provision to the SCGB 100. In some implementations, by way of example and not limitation, a controller(s) of the SCGB 100 and/or the water conditioning/treatment system may determine a water attributes profile (e.g., chemical composition, electrical attributes, temperature attributes) (e.g., based on target plant and/or soil profiles, based on sensor feedback). The treatment system 1450 may, for example, condition the water as a function of the water attributes profile for the corresponding SCGB(s) 100 (e.g., individually, in groups, for all connected SCGB 100). In various implementations, the water pump 1425 may receive liquid from the above ground treatment system 1455. For example, the above ground treatment system 1455 may add nutrients and remove contaminants to water before delivering to the water pump 1425.

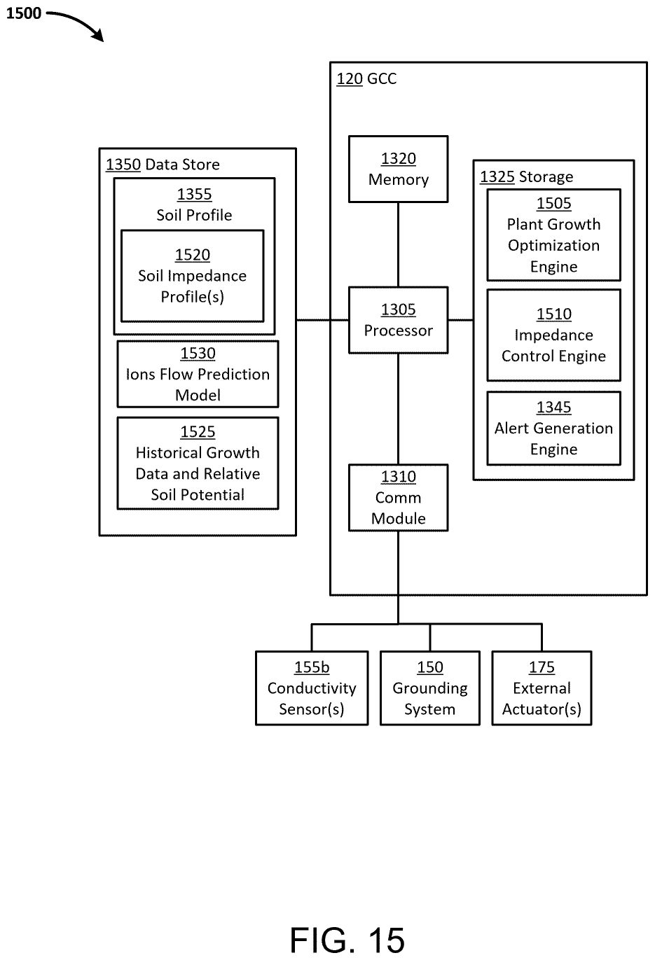

FIG. 15 is a block diagram depicting an exemplary soil impedance regulation system 1500 of an exemplary AGP. For example, soil impedance may be controlled using the exemplary soil impedance regulation system 1500. In this example, the communication module 1310 is operably coupled to the conductivity sensor 155b, the grounding system 150, and the external actuator(s) 175. For example, the conductivity sensor 155b may be disposed within the PGM 141 as described in FIG. 1A. For example, the GCC 120 may control the grounding system 150 (e.g., to operate the low power charge application device 170) to actively regulate a potential of the PGM 141 based on the conductivity sensor 155b. In some implementations, the grounding system 150 may include two or more electrodes to apply a differential potential to the PGM 141. For example, the electrodes may include an electrical ground. In some examples, the electrodes may be coupled to an inner surface of the coated walls 115. In some examples, the electrodes may be coupled to an outer surface of the coated walls 115. By controlling the charge applied at the grounding system 150, the GCC 120 may control an impedance of the PGM 141 between the electrodes, for example.

The storage module 1325 includes a plant growth optimization engine (PGOE 1505) and an impedance control engine (ICE 1510). For example, the ICE 1510 may receive an electrical potential in the PGM 141 with measurements from the conductivity sensor 155b. For example, the ICE 1510 may compare the electrical potential to a target range of electrical potential as a function of a predetermined rate of ions flow specified in the soil profile 1355. For example, the target range may be generated by the PGOE 1505 (e.g., determining an ‘optimal’ range). For example, the target range may be periodically updated using a machine learning model.

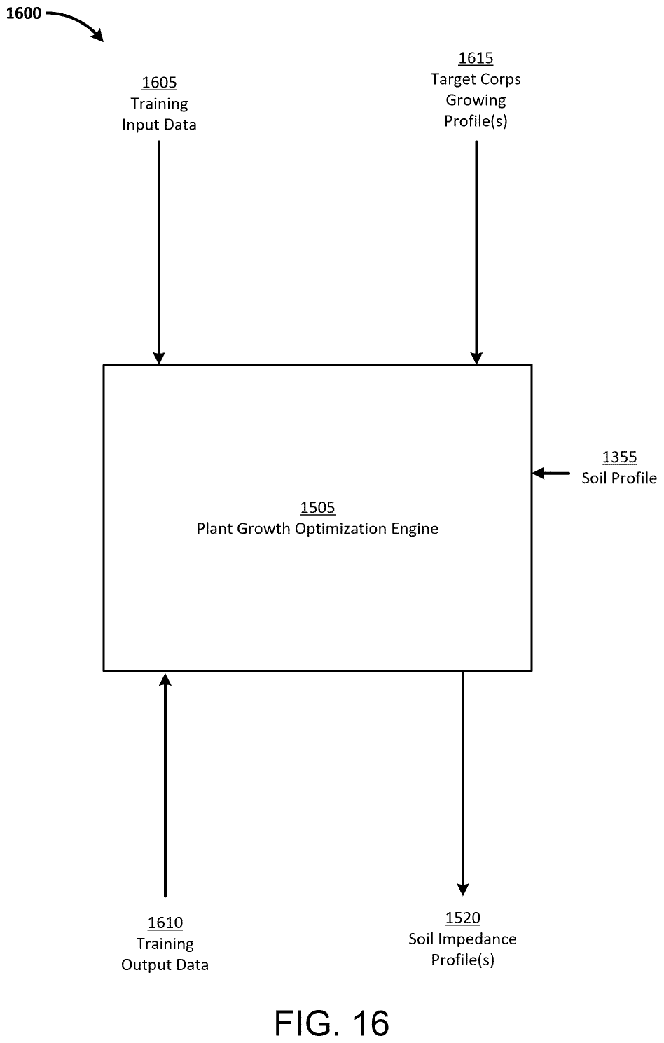

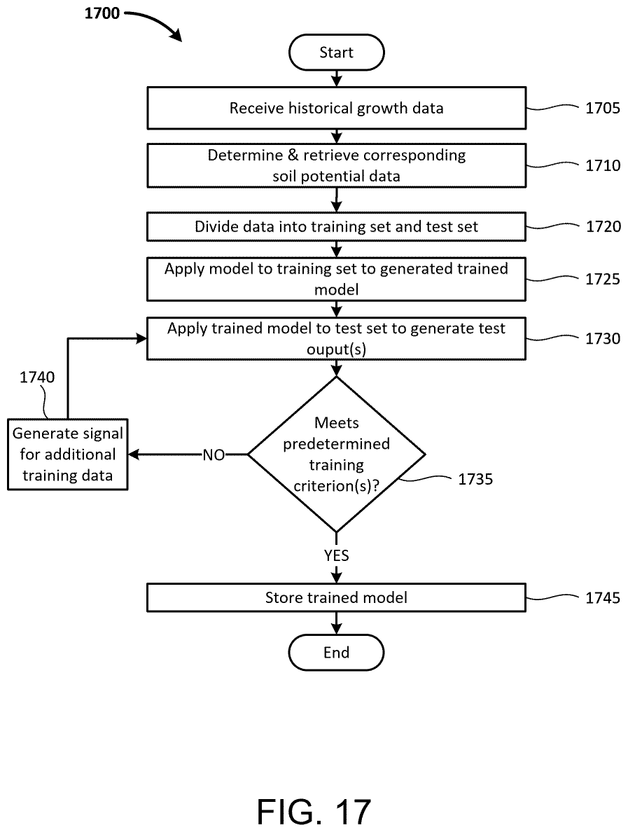

In this example, the data store 1350 includes a soil impedance profile(s) (SOPs 1520) in the soil profile 1355. For example, the SOPs 1520 may include target electrical potential range as a function of a target crops. The data store 1350 also includes a historical growth data and relative soil potential (HGDRSP 1525). For example, the PGOE 1505 may update the SOPs 1520 based on the HGDRSP 1525. Some embodiments of the machine learning model are described with reference to FIGS. 16-17.

In some implementations, the ICE 1510 may generate a signal to control the low power charge application device 170 to adjust a current flow within the plant growing medium. For example, the ICE 1510 may generate the signal to control the impedance using exemplary relative charge differentials as described with reference to FIGS. 1A-C.

The data store 1350 includes an ion flow prediction model 1530. For example, the ICE 1510 may apply a potential difference to the ion flow prediction model 1530 to predict a temporal change in electric potential in the PGM 141. For example, the ICE 1510 may control a maximum change in electric potential in the PGM 141 to advantageously protect roots of plants in the PGM 141 while regulating the plants.

In some implementations, the signal may control the grounding system 150 to generate a natural current flow through the plant growing medium. For example, the grounding system 150 may be controlled to bleed charges in the PGM 141 to the electric ground 151. For example, the grounding system 150 may be controlled to use the low power charge application device 170 to force an electric charge to flow through the plant growing medium.

FIG. 16 depicts an exemplary block diagram of the exemplary PGOE. For example, the PGOE 1505 may generate a target range of electrical potential using a machine learning model. For example, the machine learning model may be trained to predict an ion flow in the plant growing medium in a near future.

In an exemplary scenario 1600, the PGOE 1505 includes a machine learning model. The machine learning model may, by way of example and not limitation, include a neural network model. The neural network model may include, for example, recurrent neural network (RNN) and/or deep neural network (DNN). The machine learning model may, for example, include an ensemble model. Different neural network models may be selected. The number of the model layers (e.g., the hidden neurons) may also be determined based on, for example, the complexity of content descriptions and/or attributes.

A set of training data is applied to the PGOE 1505 to train the machine learning model. The training data includes a set of training input data 1605 and a set of training output data 1610. The set of training input data 1605 may include the HGDRSP 1525. The training input data 1605 may include, for example, target crops growing profile(s) 1615. For example, the target crops growing profile(s) 1615 may include growing conditions targeted (e.g., ‘optimal’) for a target crop. The training input data 1605 may include, for example, current and/or historical soil profile 1355. For example, the soil profile soil profile 1355 may include the type of PGM 141 corresponding to the training input data 1605.

The set of training output data 1610 may include historical plant growth data. For example, the historical plant growth data may include an average growth of a plant per nutrient weight. The training output data 1610 may, for example, be selected to correspond to the training input data 1605.

In some embodiments, before training, a set of testing data (including testing input data and testing output data) may be divided from the training data. After the PGOE 1505 is trained, the testing data may be applied to the trained model to test the training accuracy of the model. For example, the trained model may receive the testing input data and generate an output data in response to the testing input data. The generated output data may be compared with the testing output data to determine the prediction accuracy (e.g., based on a predetermined criterion(s) such as a maximum error threshold). In some embodiments, one or more models (e.g., neural network models) may be cascaded together. The cascaded model may be trained and tested.

During operation, the soil profile 1355 and the HGDRSP 1525 may be provided as inputs to the (trained) PGOE 1505. The PGOE 1505 may generate, in response, a SOPs 1520.

FIG. 17 depicts an exemplary method of training a PGOE. A method 1700 may, for example, be performed by a processor(s) (e.g., processor 1305) executing a program(s) of instructions retrieved from a data store(s) (e.g., data store 1350). The method 1700 includes, at a step 1705, receiving the historical growth data (e.g., HGDRSP 1525). At a step 1710, corresponding soil profiles (e.g., SOPs 1520) are determined and retrieved.

At a step 1720, the retrieved data is divided into a first set of data used for training and a second set of data used for testing. At a step 1725, a model (e.g., a model(s) of the PGOE 1505) is applied to the training data to generate a trained model (e.g., neural network model). The trained model is applied to the testing data, in a step 1730, to generate test output(s) (e.g., SOPs 1520). The output is evaluated, in a decision point 1735, to determine whether the model is successfully trained (e.g., by comparison to a predetermined training criterion(s)). The predetermined training criterion(s) may, for example, be a maximum error threshold. For example, if a difference between the actual output (the test data) and the predicted output (the test output) is within a predetermined range, then the model may be regarded as successfully trained. If the difference is not within the predetermined range, then the model may be regarded as not successfully trained. At a step 1740, the processor may generate a signal(s) requesting additional training data, and the method 1700 loops back to step 1730. If the model is determined, at the decision point 1735, to be successfully trained, then the trained model may be stored (e.g., in the storage module 1325), in a step 1745, and the method 1700 ends.

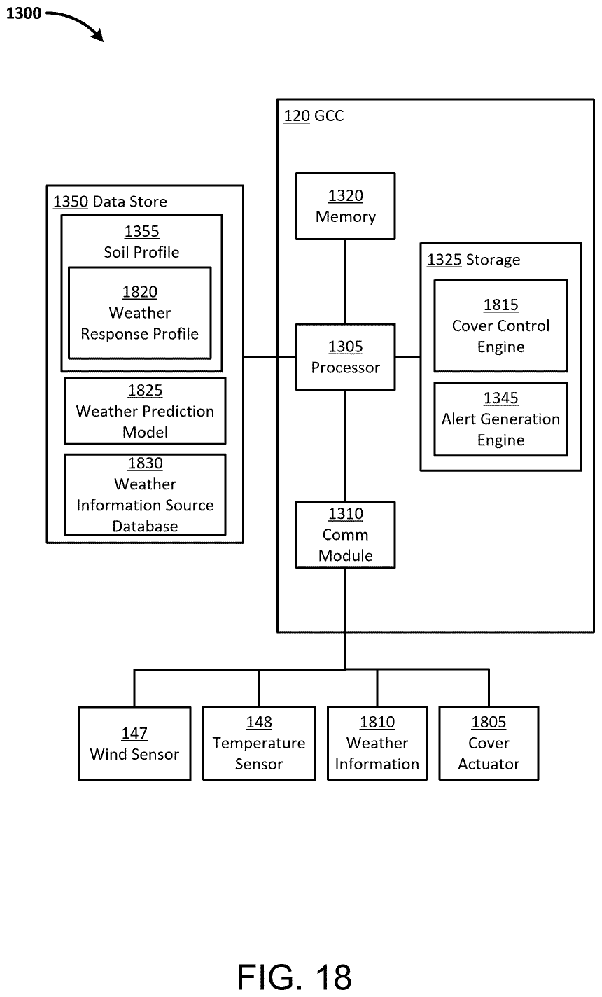

FIG. 18 is a block diagram depicting an exemplary cover control system of an exemplary AGP. In this example, the communication module 1310 is operably coupled to the wind sensor 147 and the temperature sensor 148. For example, the wind sensor 147 may measure wind speed external to the SCGB 100. For example, the temperature sensor 148 may measure a temperature external to the SCGB 100.

The communication module 1310 is further coupled to a cover actuator 1805 and a weather information module 1810. In some implementations, the cover actuator 1805 may control an open and close of the clamshell cover 145. For example, the cover actuator 1805 may include a motor. For example, the cover actuator 1805 may include a step motor. The weather information module 1810, for example, may include a local weather station or a remote weather station (e.g., the weather station 1015). In some implementations, the GCC 120 may receive weather forecasts from the Internet (e.g., using a weather application, using an application programming interface (API)) through the communication module 1310.

The storage module 1325 includes a cover control engine (CCE 1815) and the AGE 1345. In some implementations, the actuator(s) 175 may include a secure contact sensor to detect unauthorized access to the PGM 141. For example, the AGE 1345 may transmit a signal to the communication module 1310 when an unauthorized access to the PGM 141 is detected.

For example, the CCE 1815 may control the cover actuator 1805 as a function of a weather response profile 1820 in the soil profile 1355. For example, the soil profile 1355 may include a wind speed threshold and an acceptable range of temperature. For example, the cover actuator 1805 may be activated when the wind speed is higher than the wind speed threshold and/or out of the acceptable range of temperature.

In some implementations, the CCE 1815 may control the cover actuator 1805 based on a predicted weather forecast. In this example, the data store 1350 includes a weather prediction model 1825. For example, the CCE 1815 may apply a current and/or historical sensor measurement (e.g., temperature, humidity, windspeed, air pressure) to the weather prediction model 1825 to generate a predicted weather forecast. For example, the predicted weather forecast may be compared to the weather response profile 1820 to determine whether the weather information module 1810 is to be opened or to be closed.

In some implementations, the CCE 1815 may retrieve online weather information. In this example, the data store 1350 includes a weather information source database 1830.

FIG. 19 is a flowchart illustrating an exemplary soil temperature regulation method 1900. For example, the method 1900 may be performed by the 3DTGCE 1330 and/or the HECE 1335 to regulate a temperature in the PGM 141. In this example, the method 1900 begins in step 1905 when temperature measurements are received from different locations in a garden box. For example, the temperature sensors 155a may be distributedly disposed within the SCGB 100 in the PGM 141. In step 1910, a 3D temperature gradient of the garden box is generated. For example, the 3DTGCE 1330 may generate the 3D temperature matrix of the SCGB 100. Next, a temperature threshold of the garden box is received from a soil profile in step 1915. For example, the predetermined soil temperature threshold 1375 may be retrieved.

After the temperature threshold is retrieved, in step 1920, the 3D temperature gradient is compared to the temperature threshold. For example, the HECE 1335 may compare the temperature gradient generated by the 3DTGCE 1330 with the predetermined soil temperature threshold 1375. In a decision point 1925, it is determined whether the comparison is within tolerance. For example, the HECE 1335 may generate a difference (e.g., an aggregated magnitude, an error matrix) between a generated 3D temperature gradient and the predetermined soil temperature threshold 1375. If the comparison is within tolerance, the method 1900 ends.

If the comparison is not within tolerance, in step 1930, a maximum rate of temperature change is retrieved. For example, the maximum rate of temperature change 1380 may be retrieved. Next, in step 1935, a temperature control signal is generated as a function of the comparison and the maximum rate of temperature change, and the method 1900 ends.

In various implementations, the 3DTGCE 1330 may use a Spatial FFT (Fast Fourier Transform) to generate a 3D temperature gradient in a plant growing volume by manipulating frequency components of a given temperature distribution (e.g., as received from the temperature sensors 155a at present time). For example, the data store 1350 may include a historical 3D temperature gradient matrix. The 3DTGCE 1330 may apply a spatial FFT algorithm to the historical 3D temperature gradient matrix and a present time 3D temperature gradient matrix to transform it into the frequency domain. In some implementations, the 3DTGCE 1330 may generate a temperature control signal based on frequency components of the temperature distribution in the frequency domain to achieve a soil temperature gradient based on the predetermined soil temperature threshold 1375 and the maximum rate of temperature change 1380. For example, the 3DTGCE 1330 may perform an inverse spatial FFT to transform the temperature control signal in frequency domain them back into the spatial domain. For example, the transformation may generate a control signal distribution that may generate a desired 3D temperature gradient.

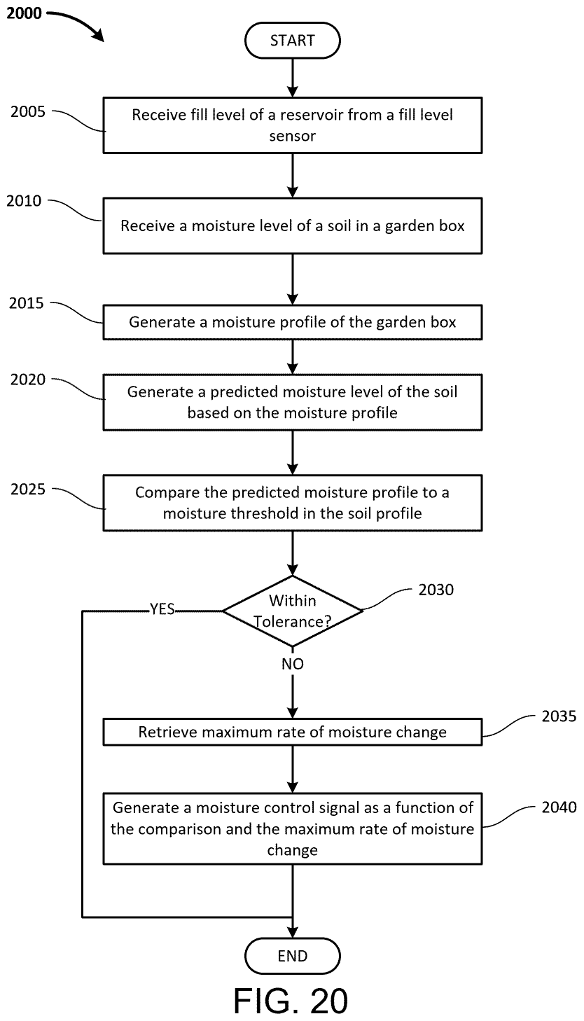

FIG. 20 is a flowchart illustrating an exemplary soil moisture regulation method 2000. For example, the RCE 1405 may use the method 2000 to actively regulate soil moisture of the PGM 141. The method 2000 begins in step 2005 when a fill level of a reservoir from a fill level sensor is received. For example, the RCE 1405 may receive a liquid level of the reservoirs 130 from the water level sensor 155d. In step 2010, a moisture level of a soil in a garden box is received. For example, the RCE 1405 may receive the moisture level of the PGM 141 from the moisture sensor 155c.

In step 2015, a moisture profile of the garden box is generated. For example, the RCE 1405 may generate a spatial moisture profile of the PGM 141 based on more than one spatially distributed moisture sensor 155c. Next, a predicted moisture level of the soil based on the moisture profile is generated in step 2020. For example, the RCE 1405 may generate a 3D spatial matrix of moisture measurements in the PGM 141. In step 2025, the predicted moisture profile is compared to a moisture threshold in the soil profile. For example, the RCE 1405 may compare the moisture measurement from the moisture sensor 155c to the predetermined water level threshold 1415.

In a decision point 2030, it is determined whether the comparison is within tolerance. For example, the RCE 1405 may generate a difference (e.g., an aggregated magnitude, an error matrix) between the predicted moisture profile and the moisture threshold. If the comparison is within tolerance, the method 2000 ends.

If the comparison is not within tolerance, in step 2035, a maximum rate of moisture change is retrieved. For example, the maximum rate of moisture change 1420 may be retrieved. Next, in step 2040, a moisture control signal is generated as a function of the comparison and the maximum rate of moisture change, and the method 2000 ends.

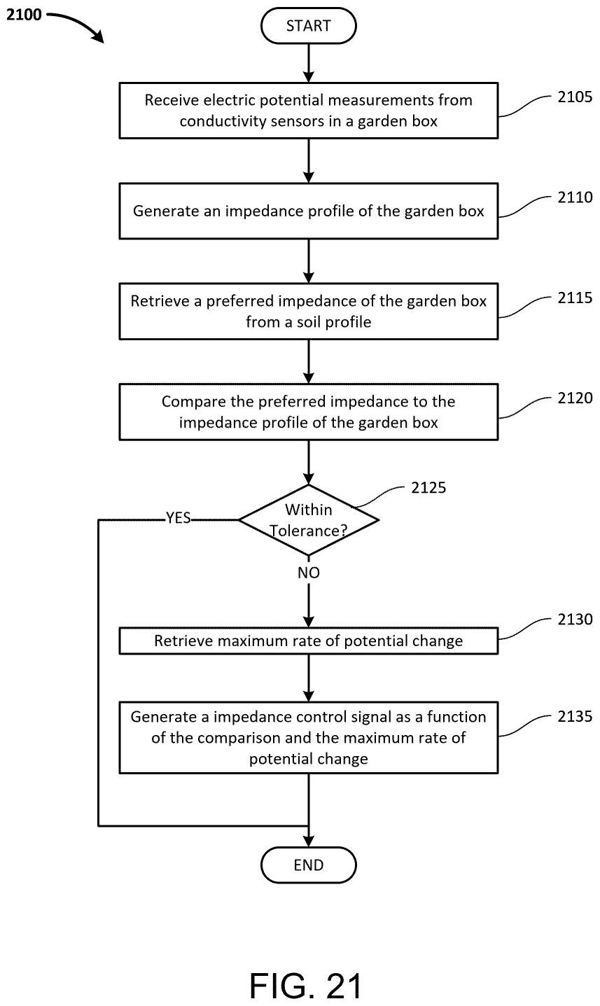

FIG. 21 is a flowchart illustrating an exemplary soil impedance regulation method 2100. For example, the method 2100 may be performed by the ICE 1510 to regulate an impedance within the PGM 141. In this example, the method 2100 begins in step 2105 when electric potential measurements are received from conductivity sensors in a garden box. For example, the conductivity sensor 155b may be distributedly disposed within the SCGB 100 in the PGM 141. In step 2110, an impedance profile of the garden box is generated. For example, the ICE 1510 may generate the impedance profile of the SCGB 100. Next, a preferred impedance of the garden box is received from a soil profile in step 2115. For example, the SOPs 1520 may be retrieved based on a machine learning model (e.g., the machine learning model as described with reference to FIGS. 14B-C). For example, the preferred impedance may be selected from the SOPs 1520 based on a soil type and/or a target crops.

After the preferred impedance is retrieved, in step 2120, the preferred impedance is compared to the impedance profile of the garden box. In a decision point 2125, it is determined whether the comparison is within tolerance. For example, the ICE 1510 may generate a difference (e.g., an aggregated magnitude, an error matrix) between the SOPs 1520 and the impedance profile. If the comparison is within tolerance, the method 2100 ends.

If the comparison is not within tolerance, in step 2130, a maximum rate of potential change is retrieved. For example, the maximum rate of potential change may be retrieved from the soil profile 1355 based on the target crops. Next, in step 2135, an impedance control signal is generated as a function of the comparison and the maximum rate of potential change, and the method 1900 ends. For example, the ICE 1510 may control the grounding system 150 to apply a potential differential between two or more points in the SCGB 100.

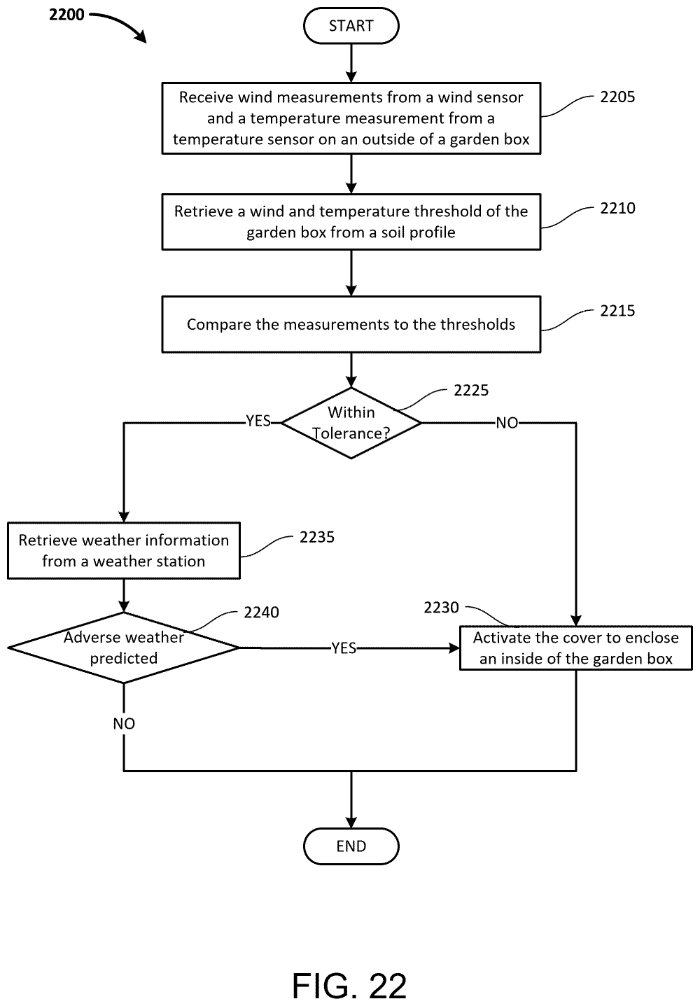

FIG. 22 is a flowchart illustrating an exemplary garden pod cover control method 2200. For example, the CCE 1815 may use the method 2200 to control the clamshell cover 145. In this example, the method 2200 begins when, in step 2205, wind measurements from a wind sensor and a temperature measurement are received from a temperature sensor on an outside of a garden box. For example, the GCC 120 may receive wind measurements and an ambient temperature from the wind sensor 147 and the temperature sensor 148.

Next, a wind threshold and a temperature threshold of the garden box is retrieved from a soil profile in step 2210. For example, the CCE 1815 may retrieve the weather response profile 1820 to retrieve a threshold for wind and temperature of a crops growing in the SCGB 100. In step 2215, the measurements are compared to the thresholds.

In a decision point 2225, it is determined whether the comparison is within a tolerance. For example, the weather response profile 1820 may specify a maximum tolerance. In step 2230, if the comparison is not within tolerance, the cover is activated to enclose an inside of the garden box, and the method 2200 ends. For example, the CCE 1815 may activate the cover actuator 1805 to close the SCGB 100.

If the comparison is within tolerance, in step 2235, weather information is retrieved from a weather station. For example, the CCE 1815 may retrieve weather forecasts from the weather information module 1810. In a decision point 2240, it is determined whether adverse weather is predicted. For example, the CCE 1815 may use the weather prediction model 1825 and the weather information received from the weather information module 1810 to predict weather within a near future (e.g., 10 minutes, 30 minutes, 1 hour). For example, an adverse weather may be predicted (e.g., a heavy rain, a storm, a strong wind, high UV level) when the weather information is applied to the weather prediction model 1825. For example, the one or more garden pod sensors 1005 (FIG. 10) may include photodiodes to measure light. For example, the one or more garden pod sensors 1005 may include cadmium sulfide photoresistors to measure light. If adverse weather is predicted, the step 2230 is repeated. If adverse weather is not predicted, the method 2200 ends.

FIG. 23 is a flowchart illustrating an exemplary method 2300 to determine a protective coating to be applied to a thermal barrier layer. For example, the method 2300 may be used to determine the protective coating used in the method 900. In this example, the method 2300 begins when a substrate's deformation energy tolerance is determined in step 2305. For example, a deformation energy tolerance of the EPS of the EPS layer 820 is determined. For example, the deformation energy tolerance may be a deformation energy point for the substrate. For example, the deformation energy tolerance may be a combustion point of the substrate (e.g., for a substrate made of cork, paper, wood, other combustible materials.). In the step 2310, a coating's thermal energy transfer rate and curing time is determined. For example, the thermal energy transfer rate and curing time may be determined based on a material (e.g., composition of the protective layer 240a-b) and a thickness of the material to be applied onto the substrate.

In a decision point 2315, it is determined whether the total energy transferred by the coating is larger than the deformation energy tolerance. If the total energy transferred by the coating is not larger than the deformation energy tolerance, the method 2300 ends. If the total energy transferred by the coating is larger than the deformation energy tolerance, a composition of the coating is adjusted in step 2320. For example, graphene may be added to the composition to reduce the energy transfer rate. For example, borate may be added to the composition to reduce the energy transfer rate. In step 2325, application thickness of the coating is adjusted, and the step 2310 is repeated. For example, the application thickness may be reduced to reduced curing time of the coating.

Although various embodiments have been described with reference to the figures, other embodiments are possible. In some implementations, the exemplary layered garden wall manufacturing method 900 and the method 2300 may be used to create coated boxes of other layer structure. For example, a user may use the exemplary layered garden wall manufacturing method 900 to create a longer than 100 feet box without screw nor mold by holding substrates together with one or more inner PU layer 205 (e.g., polyurea). For example, the exemplary garden wall 230 may include only the thermal barrier layer 235 and the protective layer 240a,b without the aerogel putty layer 245 and/or the HSL 250. In some implementations, the HSL 250 may include a thin layer of graphene.

In various implementations, the PGOE 1505 may be implemented in the AGP 1300 for temperature regulation (FIG. 13), moisture regulation (FIG. 14), and/or cover control (FIG. 18). In some implementations, the SCGB 100 may include wheels to, for example, track the Sun along with protecting the garden during cold weather nights or bad weather by traveling to a shelter that opens the door if needed. The next day, for example, the garden may travel back into the yard automatically by taking in data from the nearest weather station to proceed. If the weather is not favorable, the garden remains in the shelter and turns on the LED grow lights during the daytime hours until the weather turns favorable. Having a garden that is mobile opens the door for those with a disability that confines them to a wheelchair such as the elderly to the Veterans of this great nation, to name a few, by calling the garden to show up at a specific time on their back porch.

With GPS tracking and a RFID tag, for example, the external actuators(s) 175 may include a fly-by drone to capture digital photos of the SCGB 100 periodically. Using artificial intelligence (AI), in some implementations, the photos may be scanned and processed to determine from growth performance to degradation caused by pests, disease and blight of the leaves and fruit. In some implementations by aggregating data from an array of gardens within a geographical proximity, a central service provider may determine to dispatch a service crew to further investigate and/or provide remedies that mitigate or stop an identified issue using safe non-toxic approved products in the Urban and Suburban areas. For example, the array of gardens may collectively generate information and/or predictive information to regulate conditions within the gardens (e.g., networked containers).

Although an exemplary system has been described with reference to FIGS. 1A-C, other implementations may be deployed in other industrial, scientific, medical, commercial, and/or residential applications. In some implementations, used SCGBs may be recyclable. To prevent seeing them thrown on top of a landfill, the SCGB 100 may be recycled in and sold back out to the market as a refurbished unit.

In various implementations, a structure constructed using at least some components of the SCGB 100 may be used in other applications. For example, such a container may be configured as a Composting Bin. Such a container may, for example, be configured as a Mushroom Farm, a Cannabis Farm, or some combination thereof. In some implementations, such a container may be configured, for example, as a Beehive. Such a container may, for example, be configured as a Bird House. In some implementations, such a container may, for example, be configured as a Dog House. Such a container may, for example, be configured as a Horse Trough, Cattle Trough, Livestock Trough (e.g., feed, water), or some combination thereof. In some implementations, such a container may, by way of example and not limitation, be configured as a Water Storage Tank. In some implementations such a container may, for example, be configured as an Athletic Ice Bath. By way of example and not limitation, such a container may be implemented as a Hunting Blind. In some implementations, such a container may, for example, be configured as a Boat. Other implementations are possible using, for example, construction techniques and/or structures disclosed herein.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, a modular gardening box may include a plant growing volume defined by four side walls. For example, the plant growing volume may be configured to hold a plant growing medium. For example, a wicking bed disposed below the plant growing volume may include a liquid reservoir. For example, the plant growing medium may be moisturized by liquids in the liquid reservoir by wicking. For example, a heating element disposed in at least one of the side walls and configured to be in direct with the plant growing medium. For example, the side walls may include a thermal barrier layer coated on opposite sides, each side by a protective layer of quick curing material, and the protective layer may be heat resistant. For example, the heating element may be disposed at an outer surface of an inner coating of the at least one of the side walls. For example, the protective layer may thermally separate the thermal barrier layer from thermal energy generated by the heating element.

For example, the protective layer of any and/or any combination of the modular gardening box of [0187-96] may include aromatic polyurea.

For example, the protective layer of any and/or any combination of the modular gardening box of [0187-96] may include polyurethane.

For example, the protective layer of any and/or any combination of the modular gardening box of [0187-96] may include a material hardness between shore durometer between 25 D and 60 D.

For example, the quick curing material of any and/or any combination of the modular gardening box of any and/or any combination of [0187-96] cures within 10 seconds after application.

For example, the thermal barrier layer of any and/or any combination of the modular gardening box of [0187-96] may include expanded polystyrene.

For example, the heating element of any and/or any combination of the modular gardening box of any and/or any combination of [0187-96] may include a graphene heat trace.

For example, an inner protective layer of any and/or any combination of the modular gardening box of any and/or any combination of [0187-96] configured to be inward facing and in contact with the plant growing medium further may include aerogel.

For example, the heating element of any and/or any combination of the modular gardening box of any and/or any combination of [0187-96] may be disposed between the aerogel and the inner protective layer.

For example, the inner protective layer of any and/or any combination of the modular gardening box of any and/or any combination of [0187-96] further may include a conductive substrate sandwiched between the heating element and an outer surface of the inner protective layer.

For example, the modular gardening box of any and/or any combination of [0187-96] may include the port member of any and/or any combination of [0267-0276]. For example, the modular gardening box of any and/or any combination of [0187-96] may include the modular gardening box of any and/or any combination of [0256-0265]. For example, the modular gardening box of any and/or any combination of [0187-96] may include the modular gardening box of any and/or any combination of [0245-0254]. For example, the modular gardening box of any and/or any combination of [0187-96] may include the modular gardening box of any and/or any combination of [0234-43]. For example, the modular gardening box of any and/or any combination of [0187-96] may include the modular gardening box of any and/or any combination of [0223-0232]. For example, the modular gardening box of any and/or any combination of [0187-96] may include the container wall manufacturing process of any and/or any combination of [0198-0211]. For example, the modular gardening box of any and/or any combination of [0187-96] may include the modular gardening box of any and/or any combination of [0213-21].

In an illustrative aspect, a container wall manufacturing process may include construct a container by providing a thermal barrier layer in the shape of the container. For example, the thermal barrier layer may include a predetermined maximum rate of thermal energy corresponding to damage of the thermal barrier layer. For example, the process may include apply a liquid protective coating, prior to completion of an exothermic curing process of the liquid protective coating into a solid. For example, the thermal barrier may be encapsulated. For example, at least one of thickness of application of the liquid protective coating and chemical composition corresponding to curing time of the liquid protective coating may be selected such that a thermal energy transmitted into the thermal barrier layer during the curing process does not exceed the predetermined maximum rate of thermal energy corresponding to damage of the thermal barrier layer.

For example, the protective coating of any and/or any combination of the container wall manufacturing process of any and/or any combination of [0198-211] may include polyurea resins.

For example, the protective coating of any and/or any combination of the container wall manufacturing process of any and/or any combination of [0198-211] may include a polyurea spray coating.

For example, the protective coating of any and/or any combination of the container wall manufacturing process of any and/or any combination of [0198-211] may be applied at an application temperature higher than 120° F.

For example, the substrate of any and/or any combination of the container wall manufacturing process of any and/or any combination of [0198-211] may include a thermoplastic material and the predetermined maximum rate of thermal energy may include a predetermined deformation energy. For example, the damage may include deformation. For example, the curing time may be less than 10 seconds such that an aggregation of the application temperature and the curing time may be less than the predetermined deformation energy. For example, the thermal barrier layer may be prevented from deforming throughout the process.

The process of any and/or any combination of the container wall manufacturing process of any and/or any combination of [0198-211] may include apply a reflective layer to the thermal barrier layer prior to application of the liquid protective coating.

For example, the reflective layer of any and/or any combination of the container wall manufacturing process of any and/or any combination of [0198-211] may include aerogel.

For example, the protective coating of any and/or any combination of the container wall manufacturing process of any and/or any combination of [0198-211] may include polyetheramines.

For example, the protective coating of any and/or any combination of the container wall manufacturing process of any and/or any combination of [0198-211] may include low-functional isocyanate pre-polymer.

For example, the protective coating of any and/or any combination of the container wall manufacturing process of any and/or any combination of [0198-211] may include an aliphatic chain extender.

For example, the protective coating of any and/or any combination of the container wall manufacturing process of any and/or any combination of [0198-211] may include an aromatic chain extender.

For example, the thermal barrier layer of any and/or any combination of the container wall manufacturing process of any and/or any combination of [0198-211] may include expanded polystyrene.

For example, the container of any and/or any combination of the container wall manufacturing process of any and/or any combination of [0198-211] may include a layered garden wall may include the thermal barrier layer and the protective coating. For example, when the layered garden wall may be a soil plate configured to separate a liquid reservoir and a plant growing volume, then, before applying the protective coating, making at least one cutout hole in the thermal barrier layer of the layered garden wall. For example, a wicking feature may be installed at the at least one cutout hole when a modular gardening box may be assembled with the layered garden wall.

For example, the container of any and/or any combination of the container wall manufacturing process of any and/or any combination of [0198-211] may include, before applying the protective coating, dispose a heat trace layer on at least one side of the reflective layer. For example, the core layer may include the thermal barrier layer, the reflective layer, and the heat trace layer.

For example, the modular gardening box including the container wall manufacturing process of any and/or any combination of [0198-211] may include the port member of any and/or any combination of [0267-0276]. For example, the modular gardening box including the container wall manufacturing process of any and/or any combination of [0198-211] may include the modular gardening box of any and/or any combination of [0256-0265]. For example, the modular gardening box including the container wall manufacturing process of any and/or any combination of [0198-211] may include the modular gardening box of any and/or any combination of [0245-0254]. For example, the modular gardening box including the container wall manufacturing process of any and/or any combination of [0198-211] may include the modular gardening box of any and/or any combination of [0234-43]. For example, the modular gardening box including the container wall manufacturing process of any and/or any combination of [0198-211] may include the modular gardening box of any and/or any combination of [0223-0232]. For example, the modular gardening box including the container wall manufacturing process of any and/or any combination of [0198-211] may include the modular gardening box of any and/or any combination of [0213-21]. For example, the modular gardening box including the container wall manufacturing process of any and/or any combination of [0198-211] may include the modular gardening box of any and/or any combination of [0187-96].

In an illustrative aspect, a modular gardening box may include a plant growing volume defined by at least one side wall. For example, the plant growing volume may be configured to hold a plant growing medium. For example, a wicking bed disposed below the plant growing volume may include a liquid reservoir. For example, the plant growing medium may be moisturized by liquids in the liquid reservoir by wicking. For example, a connection pipe may be fluidly connected to the liquid reservoir. For example, a flow inducing feature fluidly may be connected to through the liquid reservoir the connection pipe. For example, the flow inducing feature may be disposed vertically above the liquid reservoir and may be exposed to an external environment and ambient air. For example, a pressure differential between the ambient air and the liquid reservoir induces an airflow between the external environment and the liquid reservoir.

For example, the flow inducing feature of any of the modular gardening box of any and/or any combination of [0213-21] may include a plurality of fin elements arranged in a plurality of rotating rings. For example, the plurality of rotating rings may be concentrically disposed within the flow inducing feature. For example, each of the plurality of rotating rings may include some of the plurality of fin elements. For example, when an air flow reaches the flow inducing feature at a proximal side of the flow inducing feature, the plurality of rotating rings may be induced to rotate in a clockwise direction viewing from above. For example, the air flow may be induced to flow into the proximal side of the flow inducing feature towards the liquid reservoir through the connection pipe such that a pressure within the liquid reservoir increases and induces air within the liquid reservoir to flow towards a distal side of the flow inducing feature.

The modular gardening box of any and/or any combination of [0213-21] may include a fill pipe fluidly connected to the liquid reservoir at one end. For example, a fill vent may be releasably coupled to the fill pipe at another end. For example, the fill vent may be exposed to exposed to the external environment, and a higher pressure within the liquid reservoir than a pressure in the external environment induces air to flow out of the liquid reservoir through the fill vent.

For example, liquid may be pourable into the liquid reservoir of any of the modular gardening box of any and/or any combination of [0213-21] when the fill vent may be removed.

For example, the fill vent of the modular gardening box of any and/or any combination of [0213-21] may include a vent screen. For example, the vent screen may include a mesh such that objects may be prevented from entering the liquid reservoir.

For example, the fill vent of the modular gardening box of any and/or any combination of [0213-21] may be contoured such that unauthorized liquid may be prevented from entering the liquid reservoir.

The modular gardening box of any and/or any combination of [0213-21] may include a port member disposed at a wall of the liquid reservoir. For example, the port member may include an inner module and an outer module. For example, each of the inner module and the outer module may include a sealing member and at least one one-way engagement feature. For example, once the engagement features of the inner module and the outer module may be registered and engaged with each other in one direction, movement of the inner module and the outer module in an opposite direction may be prevented. For example, the sealing members press against the wall of the liquid reservoir to prevent leaking.

For example, when a pressure in the external environment may be lower than the pressure in the liquid reservoir of the modular gardening box of any and/or any combination of [0213-21], air within the liquid reservoir may be exchanged by releasing air in the liquid through the port member and intaking the ambient air from the flow inducing feature.

For example, the flow inducing feature of the modular gardening box of any and/or any combination of [0213-21] may be disposed at a top portion of the connecting pipe.

For example, the modular gardening box of any and/or any combination of [0213-21] may include the port member of any and/or any combination of [0267-0276]. For example, the modular gardening box of any and/or any combination of [0213-21] may include the modular gardening box of any and/or any combination of [0256-0265]. For example, the modular gardening box of any and/or any combination of [0213-21] may include the modular gardening box of any and/or any combination of [0245-0254]. For example, the modular gardening box of any and/or any combination of [0213-21] may include the modular gardening box of any and/or any combination of [0234-43]. For example, the modular gardening box of any and/or any combination of [0213-21] may include the modular gardening box of any and/or any combination of [0223-0232]. For example, the modular gardening box of any and/or any combination of [0213-21] may include the container wall manufacturing process of any and/or any combination of [0198-0211]. For example, the modular gardening box of any and/or any combination of [0213-21] may include the modular gardening box of any and/or any combination of [0187-96].

In an illustrative aspect, a modular gardening box may include a plant growing volume defined by at least one side wall. For example, the plant growing volume may be configured to hold a plant growing medium. For example, a box cover may include a protective cover and a controller. For example, the controller may be configured to automatically activate the protective cover such that, in an activated mode, the protective cover sealingly encloses the plant growing volume.

For example, the box cover of the modular gardening box of any and/or any combination of [0223-32] may include a temperature sensor and a wind sensor. For example, the controller may be configured to selectively activate the protective cover as a function of a measured temperature and wind speed.

For example, the box cover of the modular gardening box of any and/or any combination of [0223-32] may include a communication module operably coupled to the controller and a network. For example, the controller may be configured to generate a control signal such that the protective cover may be selectively activated as a function of a forecasted temperature and wind speed received via the network.

For example, the controller of the modular gardening box of any and/or any combination of [0223-32] may be configured to transmit a signal to the network when an unauthorized access to the plant growing volume may be detected.

For example, the protective cover of the modular gardening box of any and/or any combination of [0223-32] may include a roller shutter.

For example, the protective cover of the modular gardening box of any and/or any combination of [0223-32] may include a clamshell cover.

For example, the protective cover of the modular gardening box of any and/or any combination of [0223-32] may include a two-sided clamshell cover.

For example, the box cover of the modular gardening box of any and/or any combination of [0223-32] further may include a handle configured to manually activate and deactivate the protective cover.

For example, the protective cover of the modular gardening box of any and/or any combination of [0223-32] may include radiation control materials.

For example, the protective cover of the modular gardening box of any and/or any combination of [0223-32] may include ultraviolet radiation protection materials.

For example, the modular gardening box of any and/or any combination of [0223-32] may include the port member of any and/or any combination of [0267-0276]. For example, the modular gardening box of any and/or any combination of [0223-32] may include the modular gardening box of any and/or any combination of [0256-0265]. For example, the modular gardening box of any and/or any combination of [0223-32] may include the modular gardening box of any and/or any combination of [0245-0254]. For example, the modular gardening box of any and/or any combination of [0223-32] may include the modular gardening box of any and/or any combination of [0234-43]. For example, the modular gardening box of any and/or any combination of [0223-32] may include the modular gardening box of any and/or any combination of [0213-0221]. For example, the modular gardening box of any and/or any combination of [0223-32] may include the container wall manufacturing process of any and/or any combination of [0198-0211]. For example, the modular gardening box of any and/or any combination of [0223-32] may include the modular gardening box of any and/or any combination of [0187-96].

In an illustrative aspect, a modular gardening box may include a plant growing volume defined by four side walls. For example, the plant growing volume may be configured to hold a plant growing medium. For example, a wicking bed may include a liquid reservoir, the wicking bed may be configured to supply nutrients to the plant growing medium. For example, the plant growing medium may be moisturized by liquids in the liquid reservoir by wicking. For example, a fill level sensor of the liquid reservoir configured to measure a fill level of liquid in the liquid reservoir. For example, a moisture sensor configured to measure a moisture level of the plant growing medium. For example, a data store may include a soil profile may include a soil moisture profile may include a minimum fill level of the liquid reservoir and a rate of change of the moisture level of the plant growing medium as a function of the moisture level and the fill level of the liquid reservoir. For example, a controller operably coupled to the fill level sensor and the moisture sensor. For example, the controller regulates a moisture level of the plant growing medium by comparing a soil moisture profile may include a level measurement of the fill level sensor and a rate of change of the moisture level of the plant growing medium to the soil moisture profile. For example, the controller generates a signal as a function of the level measurement and the minimum fill level specified in the soil profile.

For example, upon receiving the signal, the communication module of the modular gardening box of any and/or any combination of [0234-43] generates an alert signal to notify a user to refill the liquid reservoir.

For example, the moisture sensor of the modular gardening box of any and/or any combination of [0234-43] may include multiple sensor units distributed within the plant growing medium. For example, the controller generates a three-dimensional moisture profile of the plant growing medium as a function of measurements from the multiple sensor units.

For example, the controller of the modular gardening box of any and/or any combination of [0234-43] may be configured to generate soil moisture as a function of soil resistivity.

The modular gardening box of any and/or any combination of [0234-43] may include a port member disposed at a wall of the liquid reservoir. For example, a water pump coupled to the port member. For example, the water pump may be operably coupled to the controller. For example, the signal activates the water pump to refill the liquid reservoir.

For example, the water pump of the modular gardening box of any and/or any combination of [0234-43] receives liquid from a water treatment system. For example, the water treatment system adds nutrients and removes contaminants to water before delivering to the water pump.

For example, the soil profile of the modular gardening box of any and/or any combination of [0234-43] may include a wicking model may include a predicted wicking rate of the plant growing medium. For example, the controller may generate the signal by applying the wicking model to the soil moisture profile.

For example, the wicking model of the modular gardening box of any and/or any combination of [0234-43] may include a historical soil moisture profile.

The modular gardening box of any and/or any combination of [0234-43] may include a box cover may include a protective cover, a rain sensor, a temperature sensor and a wind sensor. For example, the controller may be configured to selectively activate the protective cover as a function of the soil moisture profile, a current temperature and wind speed, and a current raining condition. For example, the controller may be configured to automatically activate the protective cover such that, in an activated mode, the protective cover sealingly encloses the plant growing volume.

For example, the controller of the modular gardening box of any and/or any combination of [0234-43] may be configured to activate the protective cover when the soil moisture profile indicates the plant growing medium may include a low moisture level. For example, it may be not raining.

For example, the modular gardening box of any and/or any combination of [0234-43] may include the port member of any and/or any combination of [0267-0276]. For example, the modular gardening box of any and/or any combination of [0234-43] may include the modular gardening box of any and/or any combination of [0256-0265]. For example, the modular gardening box of any and/or any combination of [0234-43] may include the modular gardening box of any and/or any combination of [0245-0254]. For example, the modular gardening box of any and/or any combination of [0234-43] may include the modular gardening box of any and/or any combination of [0223-0232]. For example, the modular gardening box of any and/or any combination of [0234-43] may include the modular gardening box of any and/or any combination of [0213-0221]. For example, the modular gardening box of any and/or any combination of [0234-43] may include the container wall manufacturing process of any and/or any combination of [0198-0211]. For example, the modular gardening box of any and/or any combination of [0234-43] may include the modular gardening box of any and/or any combination of [0187-96].

In an illustrative aspect, a modular gardening box may include a plant growing volume defined by four side walls. For example, the plant growing volume may be configured to hold a plant growing medium. For example, a wicking bed may include a liquid reservoir. For example, the wicking bed may be configured to supply nutrients to the plant growing medium. For example, the plant growing medium may be moisturized by liquids in the liquid reservoir by wicking. For example, a data store may include a soil profile may include temperature threshold matrix. For example, the modular gardening box may include a plurality of temperature sensors. For example, the plurality of temperature sensors may be distributed throughout the plant growing medium. For example, a controller may operably be coupled to the plurality of temperature sensors. For example, the controller controls a temperature of the plant growing medium by (a) generating a 3D temperature matrix of the plant growing medium. For example, (b) comparing the 3D temperature matrix to the temperature threshold matrix of the soil profile. For example, (c) generating a temperature control signal as a function of a compare result.

For example, the plurality of temperature sensors of the modular gardening box of any and/or any combination of [0245-54] may be distributed at sensor locations in at least at each side and at a bottom of the plant growing volume. For example, the 3D temperature matrix may be generated by interpolating temperature measurements in each of the sensor locations.

For example, the controller of the modular gardening box of any and/or any combination of [0245-54] may be further configured to generate the temperature control signal as a function of a predicted weather condition.

For example, the controller of the modular gardening box of any and/or any combination of [0245-54] further may include a communication module. For example, upon receiving the temperature control signal, the communication module generates an alert signal to notify a user of the compare result.

The modular gardening box of any and/or any combination of [0245-54] may include heating elements disposed on at least two of the four side walls. For example, the heating elements may be activated by the temperature control signal.

For example, the soil profile of the modular gardening box of any and/or any combination of [0245-54] may include a maximum rate of temperature change in the plant growing medium. For example, the controller generates the temperature control signal as a function of the maximum rate of temperature change. For example, the heating elements supply thermal energy to the plant growing medium at a rate of change in a soil temperature less than or equal to the maximum rate specified in the soil profile.

For example, the heating elements of the modular gardening box of any and/or any combination of [0245-54] may include a graphene heat trace.

For example, the heating elements of the modular gardening box of any and/or any combination of [0245-54] may include infrared carbon sheets.

For example, the heating elements of the modular gardening box of any and/or any combination of [0245-54] may include nichrome wire.

For example, the heating elements of the modular gardening box of any and/or any combination of [0245-54] may include laminated siliconized rubber with a carbon core.

For example, the modular gardening box of any and/or any combination of [0245-54] may include the port member of any and/or any combination of [0267-0276]. For example, the modular gardening box of any and/or any combination of [0245-54] may include the modular gardening box of any and/or any combination of [0256-0265]. For example, the modular gardening box of any and/or any combination of [0245-54] may include the modular gardening box of any and/or any combination of [0234-0243]. For example, the modular gardening box of any and/or any combination of [0245-54] may include the modular gardening box of any and/or any combination of [0223-0232]. For example, the modular gardening box of any and/or any combination of [0245-54] may include the modular gardening box of any and/or any combination of [0213-0221]. For example, the modular gardening box of any and/or any combination of [0245-54] may include the container wall manufacturing process of any and/or any combination of [0198-0211]. For example, the modular gardening box of any and/or any combination of [0245-54] may include the modular gardening box of any and/or any combination of [0187-96].

In an illustrative aspect, a modular gardening box may include a plant growing volume defined by four side walls. For example, the plant growing volume may be configured to hold a plant growing medium. For example, a wicking bed may include a liquid reservoir. For example, the wicking bed may be configured to supply nutrients to the plant growing medium. For example, the plant growing medium may be moisturized by liquids in the liquid reservoir by wicking. For example, a data store may include a soil profile may include a target range of electrical potential as a function of a predetermined rate of ions flow. For example, a grounding system may include a potential sensor disposed within the plant growing medium, an electrical ground, and a low power charge application device. For example, a controller may be operably coupled to the grounding system. For example, the controller may be configured to actively control an impedance of the plant growing medium. For example, the controller controls the impedance of the plant growing medium from the low power charge application device to the electrical ground by (a) monitor an electrical potential in the plant growing medium with measurements from the potential sensor, (b) compare the electrical potential to a target range of electrical potential as a function of a predetermined rate of ions flow specified in the soil profile, and (c) generate a signal to control the low power charge application device to adjust a current flow within the plant growing medium.

For example, the potential sensor of the modular gardening box of any and/or any combination of [0256-65] may include a conductivity sensor.

For example, the potential sensor of the modular gardening box of any and/or any combination of [0256-65] may include a graphene electric field sensor.

For example, the electrical ground of the modular gardening box of any and/or any combination of [0256-65] may be coupled to a ground of a building. For example, discharging electrical potential may be safe.

For example, the low power charge application device of the modular gardening box of any and/or any combination of [0256-65] may include a small DC charge applied to an outer surface of at least one of the side walls.

For example, the low power charge application device of the modular gardening box of any and/or any combination of [0256-65] may include an electrode inserted in the plant growing medium.

For example, the signal to control the low power charge application device of the modular gardening box of any and/or any combination of [0256-65] may induce operations that may include generate a natural current flow through plant growing medium, bleed charges in the plant growing medium to the electrical ground, and force an electric charge to flow through the plant growing medium.

For example, target range of electrical potential of the modular gardening box of any and/or any combination of [0256-65] may be determined by a machine learning model. For example, the machine learning model may be trained to predict an ion flow in the plant growing medium in a near future.

For example, the machine learning model of the modular gardening box of any and/or any combination of [0256-65] may be trained by historical electric potential measurement of the plant growing medium, a soil profile may include a type of the plant growing medium and a target crops growing profile.

For example, the controller of the modular gardening box of any and/or any combination of [0256-65] may include a communication module. For example, the controller may be configured to transmit an alert signal using the communication module when an electrical potential in the plant growing medium may be above a predetermined threshold.

For example, the modular gardening box of any and/or any combination of [0256-0265] may be included in the port member of any and/or any combination of [0267-0276]. For example, the modular gardening box of any and/or any combination of [0256-0265] may be included in the modular gardening box of any and/or any combination of [0245-0254]. For example, the modular gardening box of any and/or any combination of [0256-0265] may be included in the modular gardening box of any and/or any combination of [0234-0243]. For example, the modular gardening box of any and/or any combination of [0256-0265] may be included in the modular gardening box of any and/or any combination of [0223-0232]. For example, the modular gardening box of any and/or any combination of [0256-0265] may be included in the modular gardening box of any and/or any combination of [0213-0221]. For example, the modular gardening box of any and/or any combination of [0256-0265] may be included in the container wall manufacturing process of any and/or any combination of [0198-0211]. For example, the modular gardening box of any and/or any combination of [0256-0265] may be included in the modular gardening box of any and/or any combination of [0187-96].

In an illustrative aspect, a port member for creating a bulkhead across a wall may include an inner module and an outer module. For example, each of the inner module and the outer module may include a sealing member and at least one one-way engagement feature. For example, once the engagement features of the inner module and the outer module may be registered and engaged with each other in one direction, movement of the inner module and the outer module in an opposite direction may be prevented. For example, the sealing members may press against the wall to prevent leaking.

For example, the sealing members of the port member of any and/or any combination of [0267-72] may include a low durometer material less than Shore A 20. For example, the sealing members of the port member of any and/or any combination of [0267-72] may include an O-ring.

For example, the engagement features of the port member of any and/or any combination of [0267-72] may be deformed upon engaging with each other.

For example, the engagement features of the port member of any and/or any combination of [0267-72] may be configured to couple across a wall thicker than 2 inches.

The port member of any and/or any combination of [0267-72] may include a valve such that a flow direction at the port member may be controlled by the valve.

The port member of any and/or any combination of [0267-72] embodied in a modular gardening box. The modular gardening box may include a plant growing volume configured to hold a plant growing medium. For example, a wicking bed may be separated from the plant growing volume by a soil plate. For example, the wicking bed may include a liquid reservoir configured to supply nutrients to the plant growing medium. For example, the liquid reservoir may be enclosed by wall panels. For example, the port member may be coupled to one of the wall panels of the liquid reservoirs. For example, an entrance and exit of liquid to and from the liquid reservoir may be provided.

The modular gardening box of any and/or combination of [0273-76] may include a water pump coupled to the port member, wherein the water pump is configured to supply liquid to refill the liquid reservoir.

The modular gardening box of any and/or combination of [0273-76] may include two port members. For example, each of the two port members may be coupled to opposite sides of the liquid reservoir.

For example, the port member of any and/or any combination of [0267-76] may be installed below a bottom surface of the soil plate, such that air is allowed to move in and out of the wicking bed through the port member.

For example, the port member of any and/or any combination of [0267-0276] may be included in the modular gardening box of any and/or any combination of [0256-0265]. For example, the port member of any and/or any combination of [0267-0276] may be included in the modular gardening box of any and/or any combination of [0245-0254]. For example, the port member of any and/or any combination of [0267-0276] may be included in the modular gardening box of any and/or any combination of [0234-0243]. For example, the port member of any and/or any combination of [0267-0276] may be included in the modular gardening box of any and/or any combination of [0223-0232]. For example, the port member of any and/or any combination of [0267-0276] may be included in the modular gardening box of any and/or any combination of [0213-0221]. For example, the port member of any and/or any combination of [0267-0276] may be included in the container wall manufacturing process of any and/or any combination of [0198-0211]. For example, the port member of any and/or any combination of [0267-0276] may be included in the modular gardening box of any and/or any combination of [0187-96].

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A modular gardening box comprising:
a plant growing volume defined by four side walls, wherein the plant growing volume is configured to hold a plant growing medium;
a wicking bed disposed below the plant growing volume comprising a liquid reservoir, wherein the plant growing medium is moisturized by liquids in the liquid reservoir by wicking; and,
a heating element disposed in at least one of the side walls and configured to be in direct with the plant growing medium, wherein:
the side walls comprise a thermal barrier layer coated on opposite sides, each side by a protective layer of quick curing material, and the protective layer is heat resistant, wherein the heating element is disposed at an outer surface of an inner coating of the at least one of the side walls, such that the protective layer thermally separates the thermal barrier layer from thermal energy generated by the heating element.

2. The modular gardening box of claim 1, wherein the protective layer comprises aromatic polyurea.

3. The modular gardening box of claim 1, wherein the protective layer comprises polyurethane.

4. The modular gardening box of claim 1, wherein the protective layer comprises a material hardness between shore durometer between 25 D and 60 D.

5. The modular gardening box of claim 1, wherein the quick curing material cures within 10 seconds after application.

6. The modular gardening box of claim 1, wherein the thermal barrier layer comprises expanded polystyrene.

7. The modular gardening box of claim 1, wherein the heating element comprises a graphene heat trace.

8. The modular gardening box of claim 1, wherein an inner protective layer configured to be inward facing and in contact with the plant growing medium further comprises aerogel.

9. The modular gardening box of claim 8, wherein the heating element is disposed between the aerogel and the inner protective layer.

10. The modular gardening box of claim 9, wherein the inner protective layer further comprises a conductive substrate sandwiched between the heating element and an outer surface of the inner protective layer.

11-83. (canceled)

84. The modular gardening box of claim 1, further comprising:
a connection pipe fluidly connected to the liquid reservoir; and,
a flow inducing feature fluidly connected to through the liquid reservoir the connection pipe, wherein the flow inducing feature is disposed vertically above the liquid reservoir and is exposed to an external environment and ambient air, such that a pressure differential between the ambient air and the liquid reservoir induces an airflow between the external environment and the liquid reservoir.

85. The modular gardening box of claim 1, further comprising:
a box cover comprising a protective cover and a controller, wherein the controller is configured to automatically activate the protective cover such that, in an activated mode, the protective cover sealingly encloses the plant growing volume.

86. The modular gardening box of claim 1, further comprising:
a fill level sensor of the liquid reservoir configured to measure a fill level of liquid in the liquid reservoir;
a moisture sensor configured to measure a moisture level of the plant growing medium;
a data store comprising a soil profile comprising a soil moisture profile comprising a minimum fill level of the liquid reservoir and a rate of change of the moisture level of the plant growing medium as a function of the moisture level and the fill level of the liquid reservoir; and,
a controller operably coupled to the fill level sensor and the moisture sensor, wherein
the controller regulates a moisture level of the plant growing medium by comparing a soil moisture profile comprising a level measurement of the fill level sensor and a rate of change of the moisture level of the plant growing medium to the soil moisture profile, such that the controller generates a signal as a function of the level measurement and the minimum fill level specified in the soil profile.

87. The modular gardening box of claim 1, further comprising:
a data store comprising a soil profile comprising a temperature threshold matrix;
a plurality of temperature sensors, wherein the plurality of temperature sensors are distributed throughout the plant growing medium; and,
a controller operably coupled to the plurality of temperature sensors, wherein the controller controls a temperature of the plant growing medium by (a) generating a 3D temperature matrix of the plant growing medium, and (b) comparing the 3D temperature matrix to the temperature threshold matrix of the soil profile, and (c) generating a temperature control signal as a function of a compare result.

88. The modular gardening box of claim 1, further comprising:
a data store comprising a soil profile comprising a target range of electrical potential as a function of a predetermined rate of ions flow;
a grounding system comprising a potential sensor disposed within the plant growing medium, an electrical ground, and a low power charge application device; and, a controller operably coupled to the grounding system, wherein the controller is configured to actively control an impedance of the plant growing medium, wherein the controller controls the impedance of the plant growing medium from the low power charge application device to the electrical ground by:
(a) monitor an electrical potential in the plant growing medium with measurements from the potential sensor,
(b) compare the electrical potential to a target range of electrical potential as a function of a predetermined rate of ions flow specified in the soil profile, and,
(c) generate a signal to control the low power charge application device to adjust a current flow within the plant growing medium.

89. The modular gardening box of claim 1, further comprising a port member configured as a bulkhead, comprising:
an inner module and an outer module, wherein each of the inner module and the outer module comprises a sealing member and at least one one-way engagement feature, wherein: once the engagement features of the inner module and the outer module are registered and engaged with each other in one direction, movement of the inner module and the outer module in an opposite direction is prevented, such that the sealing members press against the wall to prevent leaking.
